(19) United States
(12) Patent Application Publication
(10) Pub. No.: US 2024/0142258 A1
(43) Pub. Date: May 2, 2024

(54) OBJECT DETECTION DEVICE, OBJECT DETECTION METHOD, AND STORAGE MEDIUM STORING PROGRAM

(71) Applicant: Mitsubishi Electric Corporation, Tokyo (JP)

(72) Inventors: Takuya Okamoto, Tokyo (JP); Hiroki Fujiyoshi, Tokyo (JP); Kentaro Ishikawa, Tokyo (JP); Noritaka Kokido, Tokyo (JP); Ryota Iwaizono, Tokyo (JP); Masahiro Yata, Tokyo (JP)

(73) Assignee: Mitsubishi Electric Corporation, Tokyo (JP)

(21) Appl. No.: 18/475,700

(22) Filed: Sep. 27, 2023

(30) Foreign Application Priority Data
Oct. 31, 2022 (JP) 2022-173875

(51) Int. Cl. G01C 21/00

(52) U.S. Cl. CPC G01C 21/3811; G01C 21/3893

(57) ABSTRACT

An object detection device includes: a peripheral information acquiring unit to acquire peripheral information including detection information for each of detection points detected by sensing a periphery of a current position; a vehicle information acquiring unit to acquire vehicle information including a current position and a state of a vehicle present at the current position;
a map information acquiring unit to acquire map information including a peripheral area of a current position; a traveling status recognizing unit to output traveling status information indicating a traveling state of a vehicle present at a current position and a status around the vehicle by using the peripheral information, the vehicle information, and the map information; and a peripheral information updating unit to output, for each of the detection points, information indicating certainty relating to a detection point by using the traveling status information.

### TECHNICAL FIELD

The present disclosed technology relates to an object detection technique.

### BACKGROUND ART

Some object detection techniques output a detection result around a vehicle as a detection point on the basis of a signal acquired by a sensor mounted on the vehicle.

Meanwhile, in an object detection technique, a technique for improving detection accuracy is disclosed in Patent Literature 1.

For example, the in-vehicle device of Patent Literature 1 is “An in-vehicle device that detects an object around a vehicle on the basis of captured images by a plurality of cameras mounted on the vehicle, the in-vehicle device including: an acquisition unit; a determination unit; an angle calculation unit; a detection control unit; and a detection unit. The acquisition unit acquires a traveling status of the vehicle. The determination unit determines a detection target area of the object according to the traveling status acquired by the acquisition unit. The angle calculation unit calculates an entry angle of the vehicle with respect to the detection target area according to the detection target area and the traveling status determined by the determination unit. The detection control unit changes a detection condition related to detection of the object according to the entry angle calculated by the angle calculation unit. The detection unit detects the object on the basis of the detection condition changed by the detection control unit and the captured images of the cameras.” (Abstract).

In this regard, specifically, the “entry angle” is an angle formed by an extending direction that is a direction along the shape of the detection target area and the traveling direction of the vehicle. The “detection condition” is a weighting each of a plurality of periphery monitoring cameras mounted on the vehicle or a detection intensity according to the entry angle (0020). In the case of weighting, “A camera that can accommodate the detection target area within the main imaging range is weighted as “main”, or a camera that may capture the detection target area but is likely not to accommodate the detection target area within the main imaging range is weighted as “sub”.” (0078) is performed according to the entry angle. In the case of the detection intensity, it is indicated by a degree such as “weak”, “medium”, or “strong” according to the entry angle.

As a result, the in-vehicle device of PTL 1 uses the weighting or the detection intensity corresponding to the state in which the detection target area is included for each of the captured images from the plurality of different cameras, and thus, the object in the detection target area is easily detected.

### CITATION LIST

### Patent Literature

### Patent Literature 1

JP 2020-166409 A

### SUMMARY OF INVENTION

### Technical Problem

However, in the conventional object detection technique, there is a case where an erroneous detection point erroneously detected is included in a plurality of detection points which are detection results based on a signal acquired by a sensor, and there is a problem that accuracy of each detection point in the detection result is unknown.

The in-vehicle device of PTL 1 detects the object using the weighting or the detection intensity corresponding to the state in which the detection target area is included for each of the captured images from the plurality of different cameras, and cannot solve the above problem for the detection result.

The present disclosure has been made to solve the above problems, and an object of the present disclosure is to provide an object detection technique for outputting a detection result so that accuracy of a detection point based on a signal acquired by a sensor can be recognized.

### Solution to Problem

An object detection device according to the present disclosure includes:
processing circuitry:
to acquire peripheral information including detection information for each of detection points detected by sensing a periphery of a current position;
to acquire vehicle information including a current position and a state of a vehicle present at the current position;
to acquire map information including a peripheral area of a current position;
to output traveling status information indicating a traveling state of a vehicle present at a current position and a status around the vehicle by using the peripheral information, the vehicle information, and the map information; and
to output, for each of the detection points, information indicating certainty relating to a detection point by using the traveling status information.

### Advantageous Effects of Invention

According to the present disclosure, it is possible to output a detection result so that accuracy of a detection point based on a signal acquired by a sensor can be recognized.

### BRIEF DESCRIPTION OF DRAWINGS

FIG. 1 is a diagram illustrating an example of a basic configuration of an object detection device of the present disclosure.

FIG. 2 is a flowchart illustrating an example of basic processing of the object detection device of the present disclosure.

FIG. 3 is a diagram for describing an example of a periphery detection sensor that detects a periphery.

FIG. 4 is a diagram for describing an example of a traveling status recognized by a traveling status recognizing unit in the object detection device.

FIG. 5 is a diagram illustrating an example of a configuration of an object detection device and peripheral devices of the object detection device according to a first embodiment of the present disclosure.

FIG. 6 is a diagram illustrating an example of a relationship between a map information acquiring unit and a map information source in the object detection device.

FIG. 7 is a flowchart illustrating an example of processing of the object detection device according to the first embodiment of the present disclosure.

FIG. 8 is a flowchart illustrating an example of processing by a peripheral information updating unit according to the first embodiment.

FIG. 9 is a diagram for describing an example of a periphery detection sensor that detects a periphery in a second embodiment.

FIG. 10 is a diagram illustrating an example of a configuration of an object detection device and peripheral devices of the object detection device according to the second embodiment of the present disclosure.

FIG. 11 is a flowchart illustrating an example of processing of the object detection device according to the second embodiment of the present disclosure.

FIG. 12 is a flowchart illustrating an example of processing by a peripheral information updating unit according to the second embodiment.

FIG. 13 is a diagram illustrating an example of a configuration of an object detection device and peripheral devices of the object detection device according to a third embodiment of the present disclosure.

FIG. 14 is a flowchart illustrating an example of processing of the object detection device according to the third embodiment of the present disclosure.

FIG. 15 is a flowchart illustrating an example of processing by a peripheral information updating unit according to the third embodiment.

FIG. 16 is a diagram illustrating an example of a configuration of an object detection device and peripheral devices of the object detection device according to a fourth embodiment of the present disclosure.

FIG. 17 is a flowchart illustrating an example of processing of the object detection device according to the fourth embodiment of the present disclosure.

FIG. 18 is a flowchart illustrating an example of processing by a peripheral information updating unit according to the fourth embodiment.

FIG. 19 is a first diagram for describing a priority map according to the fourth embodiment.

FIG. 20 is a second diagram for describing a priority map according to the fourth embodiment.

FIG. 21 is a diagram illustrating an example of a configuration of an object detection device and peripheral devices of the object detection device according to a fifth embodiment of the present disclosure.

FIG. 22 is a flowchart illustrating an example of processing of the object detection device according to the fifth embodiment of the present disclosure.

FIG. 23 is a flowchart illustrating an example of processing by a peripheral information updating unit according to the fifth embodiment.

FIG. 24 is a first diagram for describing priority adjustment processing according to the fifth embodiment.

FIG. 25 is a second diagram for describing priority adjustment processing according to the fifth embodiment.

FIG. 26 is a diagram illustrating an example of a configuration of an object detection device and peripheral devices of the object detection device according to a sixth embodiment of the present disclosure.

FIG. 27 is a flowchart illustrating an example of processing of the object detection device according to the sixth embodiment of the present disclosure.

FIG. 28 is a flowchart illustrating an example of processing by a peripheral information updating unit according to the sixth embodiment.

FIG. 29 is a flowchart illustrating an example of processing by a priority adjusting unit according to the sixth embodiment.

FIG. 30 is a diagram for describing a first example of an adjustment method by priority adjustment processing according to the sixth embodiment.

FIG. 31 is a diagram for describing a second example of the adjustment method by the priority adjustment processing according to the sixth embodiment.

FIG. 32 is a diagram for describing a third example of the adjustment method by the priority adjustment processing according to the sixth embodiment.

FIG. 33 is a diagram illustrating an example of a configuration of an object detection device and peripheral devices of the object detection device according to a seventh embodiment of the present disclosure.

FIG. 34 is a flowchart illustrating an example of processing of the object detection device according to the seventh embodiment of the present disclosure.

FIG. 35 is a flowchart illustrating an example of processing by a peripheral information updating unit according to the seventh embodiment.

FIG. 36 is a flowchart illustrating an example of processing by a priority adjusting unit according to the seventh embodiment.

FIG. 37 is a diagram for describing an example of a periphery detection sensor that detects a periphery and a roadside device in the seventh embodiment.

FIG. 38 is a diagram for describing an example of an adjustment method by priority adjustment processing according to the seventh embodiment.

FIG. 39 is a diagram illustrating a first example of a hardware configuration for implementing functions according to the object detection device of the present disclosure.

FIG. 40 is a diagram illustrating a second example of a hardware configuration for implementing the functions according to the object detection device of the present disclosure.

### DESCRIPTION OF EMBODIMENTS

In order to explain the present disclosure in more detail, embodiments of the present disclosure will be described below with reference to the accompanying drawings.

### First Embodiment

In a first embodiment, a basic functional configuration of an object detection device and processing by the configuration will be described.

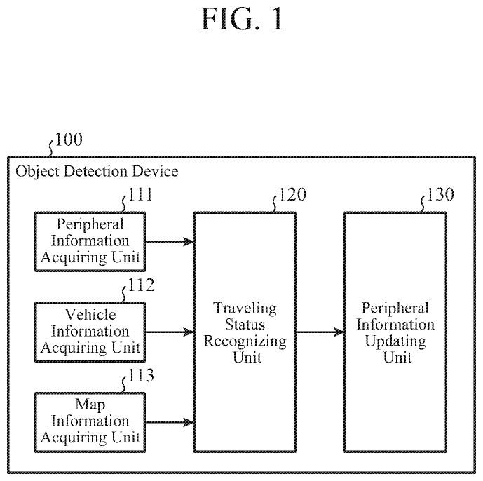

FIG. 1 is a diagram illustrating an example of a basic configuration of an object detection device 100 of the present disclosure.

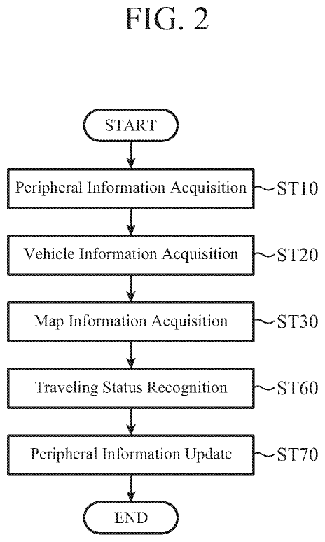

FIG. 2 is a flowchart illustrating an example of basic processing of the object detection device 100 of the present disclosure.

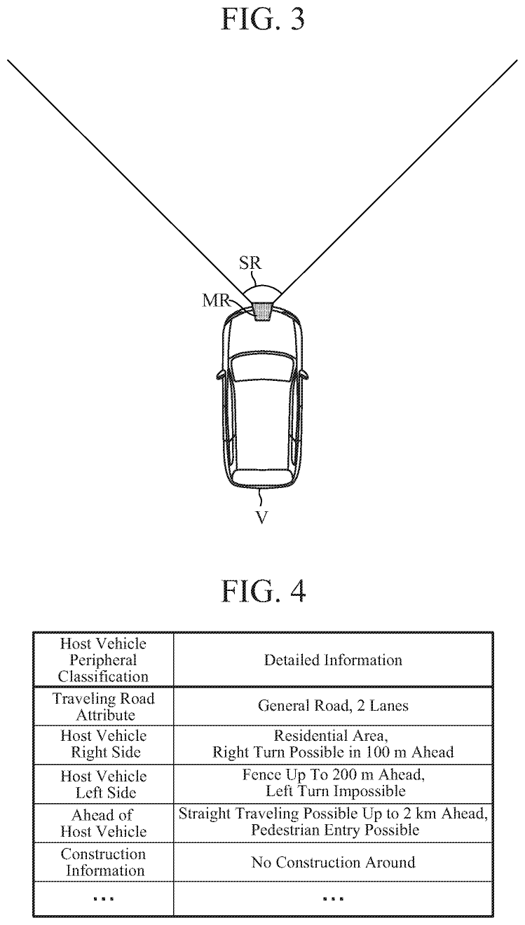

FIG. 3 is a diagram for describing an example of a periphery detection sensor 210 that detects a periphery.

FIG. 4 is a diagram for describing an example of a traveling status recognized by a traveling status recognizing unit 120 in the object detection device 100.

The object detection device 100 detects an object (target) by sensing the periphery of the current position.

The object detection device 100 can take a form of, for example, an in-vehicle device fixedly mounted on a vehicle, or a terminal device detachably mounted.

The object detection device 100 illustrated in FIG. 1 includes a peripheral information acquiring unit 111, a vehicle information acquiring unit 112, a map information acquiring unit 113, a roadside-device information acquiring unit 114, a traveling status recognizing unit 120, a peripheral information updating unit 130, a control unit (not illustrated), and a storage unit (not illustrated).

The peripheral information acquiring unit 111 acquires peripheral information including detection information for each detection point detected by sensing the periphery of the current position.

The peripheral information acquiring unit 111 acquires peripheral information from the external periphery detection sensor 210, for example.

For example, as illustrated in FIG. 3, the periphery detection sensor 210 can detect an area of a detection range “SR” by a millimeter wave radar “MR” mounted on the vehicle.

The vehicle information acquiring unit 112 acquires vehicle information including a current position and a state of a vehicle present at the current position.

The map information acquiring unit 113 acquires map information including a peripheral area of the current position.

The traveling status recognizing unit 120 outputs traveling status information indicating the traveling state of the vehicle present at the current position and the status around the vehicle by using the peripheral information, the vehicle information, and the map information.

The traveling status recognizing unit 120 compares the map information with the current position using, for example, the peripheral information, the vehicle information, and the map information, recognizes the traveling status such as host vehicle peripheral classification and detailed information thereof in addition to the traveling position of the host vehicle, the speed of the host vehicle, the traveling direction of the host vehicle, the point where the host vehicle is traveling and the state of the periphery, the position of the peripheral structure and the like, and the position of the detection point with the host vehicle as a reference, and outputs the recognition result as the traveling status information.

The host vehicle peripheral classification and the detailed information thereof are detailed information for each host vehicle peripheral classification as illustrated in FIG. 4, for example.

Specifically, the detailed information is information obtained by reading, from the acquired information, detailed information related to target detection, such as at what distance from the host vehicle, there is a point where a right or left turn is possible, a point where it is impossible for a pedestrian to jump out, or a point where it is difficult for a pedestrian to jump out. The host vehicle peripheral classification and the detailed information thereof illustrated in FIG. 4 indicate information including the traveling state of the vehicle and the status around the vehicle, in such a manner that the host vehicle peripheral classification “traveling road attribute” is the detailed information “General road, 2 lanes”, and similarly, the “Host vehicle right side” is “Residential area, Right turn possible in 100 m ahead”, the “Host vehicle left side” is “Fence up to 200 m ahead, Left turn impossible”, the “Ahead of host vehicle” is “Straight traveling possible up to 2 km ahead, Pedestrian entry possible”, the “Construction information” is “No construction around”, and . . . .

The traveling status recognizing unit 120 can implement the present disclosure also when detailed information is derived by estimation in addition to the information stored in a database 230.

The traveling status recognizing unit 120 outputs the traveling status information including the contents indicated in the detailed information.

The peripheral information updating unit 130 updates peripheral information including detection information for each detection point.

Specifically, for example, the peripheral information updating unit 130 outputs information indicating certainty relating to the detection point for each detection point using the traveling status information.

More specifically, for example, the peripheral information updating unit 130 outputs a priority that is information indicating the certainty relating to the detection point for each detection point by using the traveling status information.

The control unit (not illustrated) controls the overall operation of the object detection device 100. The control unit performs control such as turning on/off of a power source of the object detection device, start of the object detection processing, and end of the object detection processing.

The storage unit (not illustrated) holds or temporarily holds information used for processing in the object detection device 100.

The processing of the object detection device 100 will be described with reference to FIG. 2.

The object detection device 100 starts processing in response to an external command, for example, and repeats the following processing.

The object detection device 100 executes peripheral information acquisition processing (step ST10).

In the peripheral information acquisition processing, the peripheral information acquiring unit 111 in the object detection device 100 acquires peripheral information including detection information for each detection point detected by sensing the periphery of the current position.

The object detection device 100 executes vehicle information acquisition processing (step ST20).

In the vehicle information acquisition processing, the vehicle information acquiring unit 112 in the object detection device 100 acquires the vehicle information including a current position and the state of the vehicle present at the current position.

The order of the vehicle information acquisition processing and the peripheral information acquisition processing is not limited thereto. For example, the vehicle information acquisition processing and the peripheral information acquisition processing may be executed simultaneously.

The object detection device 100 executes map information acquisition processing (step ST30).

In the map information acquisition processing, the map information acquiring unit 113 in the object detection device 100 acquires map information including a peripheral area of the current position. Specifically, the map information acquiring unit 113 acquires the vehicle information from the vehicle information acquiring unit 112, refers to the database 230 storing the map information data by using the position information included in the vehicle information, and acquires the map information including the peripheral area of the current position from the database 230.

The object detection device 100 executes traveling status recognition processing (step ST60).

In the traveling status recognition processing, the traveling status recognizing unit 120 in the object detection device 100 outputs traveling status information indicating the vehicle present at the current position and the traveling status around the vehicle by using the peripheral information, the vehicle information, and the map information.

Specifically, the traveling status recognizing unit 120 acquires peripheral information from the peripheral information acquiring unit 111.

The traveling status recognizing unit 120 acquires the vehicle information from the vehicle information acquiring unit 112.

The traveling status recognizing unit 120 acquires map information from the map information acquiring unit 113.

For example, the traveling status recognizing unit 120 combines the peripheral information, the vehicle information, and the map information, recognizes a traveling status such as host vehicle peripheral classification and detailed information thereof in addition to a traveling position of the host vehicle, a speed of the host vehicle, a traveling direction of the host vehicle, a state of a place where the host vehicle is traveling, a position of a peripheral structure or the like, and a position of a detection point with the host vehicle as a reference, and outputs a recognition result as traveling status information.

The object detection device 100 executes peripheral information update processing (step ST70).

In the peripheral information update processing, the peripheral information updating unit 130 in the object detection device 100 outputs information indicating certainty relating to the detection point for each detection point using the traveling status information.

Specifically, for example, the peripheral information updating unit 130 generates and outputs information indicating the certainty relating to the detection point for each detection point according to the traveling status of the vehicle present at the current position, the position of the detection point, the position of the sensor that has detected the detection point, the type of the sensor, and the like.

While the periphery of the current position is sensed, the object detection device 100 repeatedly executes the processing from step ST10 to step ST70.

In the conventional object detection technique, there is a case where a target that does not exist is detected as an example of erroneous detection by a millimeter-wave radar as erroneous detection by a sensor, but accuracy for each detection point cannot be recognized with respect to a detection point indicating a detected target. Therefore, for example, when the detection result is used for vehicle control, unintended control that should not be performed may occur.

On the other hand, the object detection device configured as described above can recognize the accuracy for each detection point by outputting an index of certainty such as information indicating the certainty relating to the detection point for each detection point on the basis of the traveling status of the host vehicle which is the vehicle present at the current position.

Accordingly, since the accuracy for each detection point can be recognized, the automatic driving control of the vehicle using the detection result can be implemented by natural control.

The object detection device of the present disclosure will be further described with reference to a specific example of a configuration in which the object detection device is communicably connected to an in-vehicle device, a vehicle-related device, and the like.

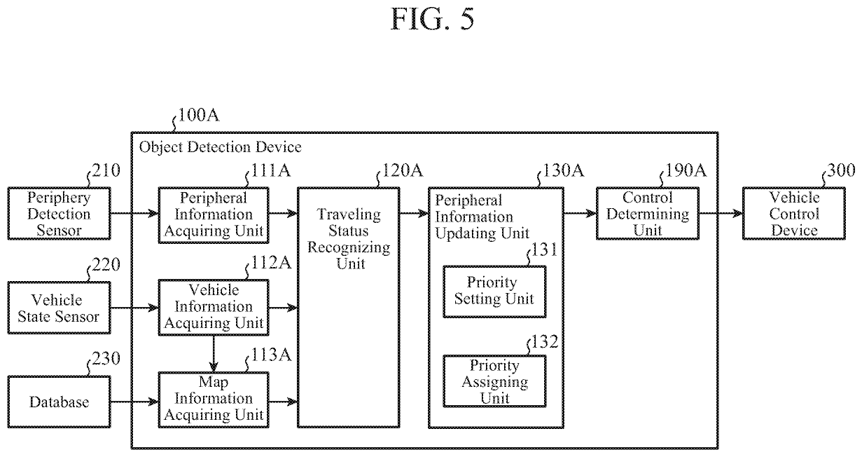

FIG. 5 is a diagram illustrating an example of a configuration of an object detection device 100A according to the first embodiment of the present disclosure and its peripheral devices.

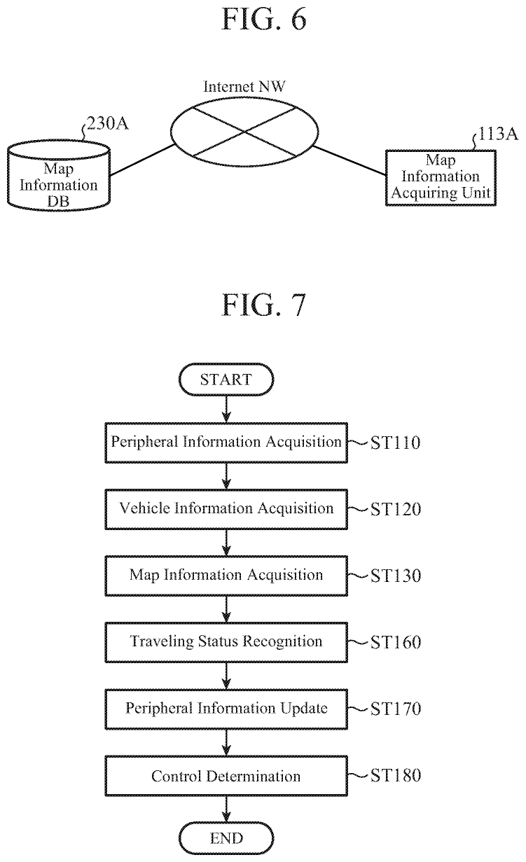

FIG. 6 is a diagram illustrating an example of a relationship between the map information acquiring unit 113A and a map information source in the object detection device 100A.

FIG. 7 is a flowchart illustrating an example of processing of the object detection device 100A according to the first embodiment of the present disclosure.

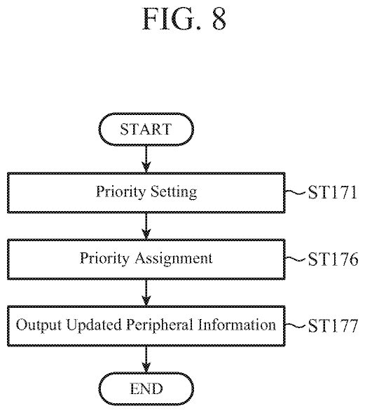

FIG. 8 is a flowchart illustrating an example of processing by a peripheral information updating unit 130A according to the first embodiment.

The object detection device 100A illustrated in FIG. 5 is communicably connected to the periphery detection sensor 210, a vehicle state sensor 220, and the database 230.

The periphery detection sensor 210 is a sensor that senses the periphery of the current position. The periphery detection sensor 210 outputs peripheral information including detection information for each detection point as a detection result of detecting the periphery of the current position.

The periphery detection sensor 210 is, for example, an in-vehicle sensor for recognizing a status around the vehicle present at the current position. Hereinafter, the “vehicle present at the current position” is also referred to as “host vehicle” in the description. In this case, the in-vehicle sensor is, for example, a sensor capable of detecting target information around the vehicle, such as a millimeter wave radar, an in-vehicle camera, or a sonar, and it is assumed that one or more of the sensors are mounted.

That is, the periphery detection sensors 210 include a periphery detection sensor group including a plurality of sensors that sense the periphery of the current position. In the case of a periphery detection sensor group, the periphery detection sensor 210 outputs detection information to which sensor identification information for identifying a sensor is added for each sensor. The sensor identification information is used to acquire information such as an installation position, a sensing direction, and a sensing range for each sensor, for example. Furthermore, the sensor identification information may include information such as an installation position, a sensing direction, and a sensing range for each sensor.

Note that the present disclosure can be implemented even when the plurality of sensors are of the same type or different types.

The vehicle state sensor 220 outputs vehicle information including a current position and a state of a vehicle present at the current position.

The vehicle state sensor 220 is, for example, a locator that is mounted on a vehicle present at the current position and can acquire position information of the vehicle. As the locator, for example, a high-definition locator (HDL) with an error of 30 cm or less is preferably used because more accurate position information can be output.

Instead of the locator, the vehicle state sensor 220 may be, for example, a global positioning system (GPS) or the like that is mounted on a vehicle present at a current position and can accurately observe position information such as latitude and longitude of the vehicle. For example, a GPS having an error of 30 cm or less is suitable because more accurate position information can be output.

In addition, the vehicle state sensor 220 includes a sensor that senses a state of the vehicle such as a speed and a yaw rate.

That is, the vehicle state sensor 220 includes a vehicle state sensor group including a plurality of types of sensors that sense the state of the vehicle.

The database 230 includes a map information database 230A.

The map information database 230A is a database that stores map information.

The map information includes attribute information and road information for each position.

The attribute information includes, for example, information indicating a type of position such as a general road, an expressway, a service area, and a private land.

The road information includes, for example, information indicating a state of a position such as a lane width, the number of lanes, and information indicating whether or not construction is in progress.

The map information database 230A may be a specification that acquires map information by communicating with an external server or a cloud or an in-vehicle internal memory as long as it is a storage medium that can sequentially acquire map information around the vehicle present at the current position, and the present disclosure can be implemented in any case.

An object detection device 100A illustrated in FIG. 5 includes a peripheral information acquiring unit 111A, a vehicle information acquiring unit 112A, a map information acquiring unit 113A, a traveling status recognizing unit 120A, a peripheral information updating unit 130A, a priority setting unit 131, a priority assigning unit 132, a control determining unit 190A, a control unit (not illustrated), and a storage unit (not illustrated).

The peripheral information acquiring unit 111A acquires peripheral information including detection information for each detection point detected by sensing the periphery of the current position, similarly to the peripheral information acquiring unit 111 described above. Specifically, the peripheral information acquiring unit 111A acquires, from the periphery detection sensor 210, peripheral information including detection information for each detection point detected by the periphery detection sensor 210.

The vehicle information acquiring unit 112A acquires vehicle information including a current position and a state of the vehicle present at the current position, similarly to the vehicle information acquiring unit 112 described above.

The vehicle information acquiring unit 112A acquires vehicle information including the current position and the state of the host vehicle (the position and state of the vehicle present at the current position) output from the vehicle state sensors 220 constituting the vehicle state sensor group.

Specifically, for example, the vehicle information acquiring unit 112A acquires information regarding the state of the host vehicle such as speed information and a yaw rate of the host vehicle in addition to the position information indicating the current position of the host vehicle obtained from the locators constituting the vehicle state sensor group.

The map information acquiring unit 113A acquires map information including a peripheral area of the current position similarly to the map information acquiring unit 113 described above.

The map information acquiring unit 113A refers to the database 230 using the vehicle information including the current position of the host vehicle to acquire map information of a peripheral area of the host vehicle (vehicle present at the current position).

Specifically, for example, the map information acquiring unit 113A uses the vehicle information received from the vehicle information acquiring unit 112 to request map information around the host vehicle from the database 230 in which the map information data is accumulated, and receives the requested map information data.

Similarly to the already described traveling status recognizing unit 120, the traveling status recognizing unit 120A outputs traveling status information indicating the traveling status of the vehicle present at the current position and the status around the vehicle by using the peripheral information, the vehicle information, and the map information.

As described above, the traveling status information includes the traveling status such as the host vehicle peripheral classification and the detailed information thereof.

The peripheral information updating unit 130A updates peripheral information including detection information for each detection point.

The peripheral information updating unit 130A sets a first priority for each position in the peripheral area of the current position using the traveling status information, and outputs a priority that is information indicating the certainty relating to the detection point for each detection point using the first priority.

The priority output by the peripheral information updating unit 130A is an index of certainty such as information indicating the certainty of detection relating to the detection point for each target (detection point) detected by the sensor. The priority is assumed to have a value in which the higher the priority, the higher the possibility that the detection is not erroneous, and the lower the priority, the higher the possibility that the detection is erroneous.

Note that, in the present disclosure, it is expressed as “priority”, but the effect of the present disclosure can be obtained without a value such as “priority” as long as it is an index indicating the certainty of detection.

The peripheral information updating unit 130A illustrated in FIG. 5 includes a priority setting unit 131 and a priority assigning unit 132.

The priority setting unit 131 sets the first priority for each detection point in the peripheral area of the current position using the traveling status information. The priority setting unit 131 uses the traveling status information to set, for example, a first priority indicating a higher priority for a detection point closer to the current position. In addition, the priority setting unit 131 uses the traveling status information to set, for example, a first priority indicating a higher priority for a detection point in a direction in which the vehicle present at the current position travels than the other detection points.

For each detection point, the priority assigning unit 132 assigns a priority, which is information indicating the certainty relating to the detection point, to peripheral information and outputs the peripheral information.

Specifically, for example, the priority assigning unit 132 assigns a priority, which is information indicating the certainty relating to the detection point for each detection point based on the first priority, to peripheral information, and outputs the updated peripheral information, which is the peripheral information assigned with the priority.

That is, in the object detection device 100A, the peripheral information updating unit 130A includes the priority setting unit 131 that sets the first priority for each detection point in the peripheral area of the current position by using the traveling status information.

In addition, the peripheral information updating unit 130A includes the priority assigning unit 132 that assigns a priority, which is information indicating certainty relating to a detection point, to peripheral information.

The peripheral information updating unit 130A outputs updated peripheral information which is peripheral information assigned with the priority by the priority assigning unit 132.

The control determining unit 190A determines control contents regarding the detection point for the vehicle present at the current position by using the information indicating the certainty relating to the detection point included in the updated peripheral information output by the peripheral information updating unit 130A. The control content regarding the detection point is, for example, a content in which, when the certainty of the detection point is high, if the detection point is in front of the vehicle, control to apply the brake is performed according to the distance to the detection point. The control determining unit 190A outputs a control command that commands the control content to a vehicle control device 300 that controls the vehicle.

The control unit (not illustrated) and the storage unit (not illustrated) are similar to the control unit and the storage unit that have already been described, and a detailed description thereof will be omitted here.

The processing of the object detection device 100A will be described.

The object detection device 100A starts processing in response to an external command, for example, and repeats the following processing.

The object detection device 100A executes peripheral information acquisition processing (step ST110).

In the peripheral information acquisition processing, the peripheral information acquiring unit 111A in the object detection device 100A acquires peripheral information including detection information for each detection point detected by sensing the periphery of the current position.

Specifically, the peripheral information acquiring unit 111A acquires the peripheral information from the periphery detection sensor 210.

The object detection device 100A executes vehicle information acquisition processing (step ST120).

In the vehicle information acquisition processing, the vehicle information acquiring unit 112A in the object detection device 100A acquires vehicle information including a current position and a state of the vehicle present at the current position. Specifically, the vehicle information acquiring unit 112A acquires the vehicle information from the vehicle state sensor 220.

The order of the vehicle information acquisition processing and the peripheral information acquisition processing is not limited thereto. For example, the vehicle information acquisition processing and the peripheral information acquisition processing may be executed simultaneously.

The object detection device 100A executes map information acquisition processing (step ST130).

In the map information acquisition processing, the map information acquiring unit 113A in the object detection device 100A acquires map information including a peripheral area of the current position. Specifically, for example, the map information acquiring unit 113A acquires the vehicle information from the vehicle information acquiring unit 112A, refers to the database 230 (map database 230A) storing the map information data via the Internet “NW” as illustrated in FIG. 6 by using the position information included in the vehicle information, and acquires the map information including the peripheral area of the current position from the database 230.

In addition, the map information acquiring unit 113A acquires map information indicating a peripheral area of the current position by accessing the database 230 as needed via the Internet “NW” by using position information indicating the current position of the host vehicle.

Alternatively, for example, the map information acquiring unit 113A acquires map information indicating a peripheral area of the current position by accessing a memory in which the map information is stored in advance as needed.

The timing of acquiring the map information may be, for example, every time the current position is acquired or every fixed time interval.

The object detection device 100A executes traveling status recognition processing (step ST160).

In the traveling status recognition processing, similarly to the traveling status recognizing unit 120 described above, the traveling status recognizing unit 120A in the object detection device 100A outputs the traveling status information indicating the traveling status of the vehicle present at the current position and the status around the vehicle by using the peripheral information, the vehicle information, and the map information.

The object detection device 100A executes peripheral information update processing (step ST170).

In the peripheral information update processing, the peripheral information updating unit 130A in the object detection device 100A outputs information indicating the certainty relating to the detection point for each detection point by using the traveling status information.

Specifically, the peripheral information updating unit 130A updates peripheral information including detection information for each detection point.

The peripheral information updating unit 130A sets a first priority for each detection point in the peripheral area of the current position by using the traveling status information, and outputs a priority that is information indicating the certainty relating to the detection point for each detection point by using the first priority.

The processing in the peripheral information updating unit 130A will be further described with reference to FIG. 8.

The peripheral information updating unit 130A executes priority setting processing (step ST171).

The priority setting unit 131 in the peripheral information updating unit 130A sets the first priority for each detection point in the peripheral area of the current position by using the traveling status information. The priority setting unit 131 sets, for example, a first priority indicating a higher priority as the detection point is closer to the current position (host vehicle) by using the traveling status information. In addition, the priority setting unit 131 uses the traveling status information to set, for example, a first priority indicating a higher priority for a detection point in a direction in which the vehicle present at the current position travels than the other detection points. The priority setting unit 131 outputs priority information indicating the set first priority for each detection point. The priority information indicating the first priority may be described as “first priority information” in order to be distinguished from the priority information indicating the priority other than the first priority in the description.

The peripheral information updating unit 130A executes priority assignment processing (step ST176).

The priority assigning unit 132 in the peripheral information updating unit 130A assigns a priority, which is information indicating the certainty relating to the detection point, to peripheral information for each detection point and outputs the peripheral information.

Specifically, for example, the priority assigning unit 132 receives the priority information from the priority setting unit 131 and acquires the first priority for each detection point, and assigns a priority, which is the information indicating the certainty relating to the detection point for each detection point based on the first priority, to peripheral information and outputs the peripheral information.

The priority assigning unit 132 determines a final priority for each detection point indicating each target.

The priority assigning unit 132 determines a detection point of a priority that does not satisfy a predetermined criterion, and deletes the detection point so as not to be included in information to be output.

Further, the priority assigning unit 132 may apply normalization processing for generating a variation in priority to the priorities of all the detection targets. As a result, the priority assigning unit 132 performs final adjustment on the priority so as to be easily used in the control determining unit 190A in the subsequent stage. Note that the present disclosure can be implemented even if the final adjustment method is not limited thereto.

The peripheral information updating unit 130A outputs the updated peripheral information (step ST177).

The peripheral information updating unit 130A outputs to the control determining unit 190A updated peripheral information which is peripheral information assigned with the priority by the priority assigning unit 132.

The description returns to FIG. 7.

The object detection device 100A executes control determination processing (step ST180).

In the control determination processing, the control determining unit 190A in the object detection device 100A determines the control content for the vehicle present at the current position by using the information indicating the certainty relating to the detection point included in the updated peripheral information output by the peripheral information updating unit 130A. The control determining unit 190A outputs a control command that commands the control content to the vehicle control device 300 that controls the vehicle.

While the periphery of the current position is sensed, the object detection device 100A repeatedly executes the processing from step ST110 to step ST180.

The object detection device of the present disclosure is configured as follows.

A peripheral information acquiring unit to acquire peripheral information including detection information for each of detection points detected by sensing a periphery of a current position;
a vehicle information acquiring unit to acquire vehicle information including a current position and a state of a vehicle present at the current position;
a map information acquiring unit to acquire map information including a peripheral area of a current position;
a traveling status recognizing unit to output traveling status information indicating a traveling state of a vehicle present at a current position and a status around the vehicle by using the peripheral information, the vehicle information, and the map information; and
a peripheral information updating unit to output, for each of the detection points, information indicating certainty relating to a detection point by using the traveling status information are provided.

Accordingly, the present disclosure can provide an object detection device that outputs a detection result so that accuracy of a detection point based on a signal acquired by a sensor can be recognized.

The object detection method of the present disclosure is configured as follows.

The object detection method using an object detection device includes:
a first step of acquiring peripheral information including detection information for each of detection points detected by sensing a periphery of a current position;
a second step of acquiring vehicle information including a current position and a state of a vehicle present at the current position;
a third step of acquiring map information including a peripheral area of a current position;
a fourth step of outputting traveling status information indicating a vehicle present at a current position and a traveling status around the vehicle by using the peripheral information, the vehicle information, and the map information; and
a fifth step of outputting, for each of the detection points, information indicating certainty relating to a detection point by using the traveling status information.

Accordingly, the present disclosure can provide an object detection method for outputting a detection result so that accuracy of a detection point based on a signal acquired by a sensor can be recognized.

The program of the present disclosure is configured as follows.

A program for causing a computer to operate as an object detection device including:
a peripheral information acquiring unit to acquire peripheral information including detection information for each of detection points detected by sensing a periphery of a current position;
a vehicle information acquiring unit to acquire vehicle information including a current position and a state of a vehicle present at the current position;
a map information acquiring unit to acquire map information including a peripheral area of a current position;
a traveling status recognizing unit to output traveling status information indicating a vehicle present at a current position and a traveling status around the vehicle by using the peripheral information, the vehicle information, and the map information; and
a peripheral information updating unit to output, for each of the detection points, information indicating certainty relating to a detection point by using the traveling status information.

As a result, the present disclosure can provide a program for outputting a detection result so that accuracy of a detection point based on a signal acquired by a sensor can be recognized.

The object detection device of the present disclosure is further configured as follows.

The peripheral information updating unit outputs, for each of the detection points, a priority that is information indicating certainty relating to the detection point by using the traveling status information.

As a result, the present disclosure can further provide an object detection device that outputs a detection result in which accuracy of a detection point is more easily recognized.

Furthermore, the present disclosure exhibits the same effect as the above effect by applying the above configuration to the object detection method or the program.

The object detection device of the present disclosure is further configured as follows.

The peripheral information updating unit includes a priority setting unit to set a first priority for each of detection points in a peripheral area of a current position by using the traveling status information, and the peripheral information updating unit outputs, for each of the detection points, the priority that is information indicating certainty relating to the detection point by using the first priority.

As a result, the present disclosure further has an effect of providing an object detection device in which the priority can be easily determined according to the position of the detection point.

Furthermore, the present disclosure exhibits the same effect as the above effect by applying the above configuration to the object detection method or the program.

The object detection device of the present disclosure is further configured as follows.

The peripheral information updating unit includes:
a priority assigning unit to assign, to the peripheral information, the priority that is information indicating certainty relating to the detection point, and
the peripheral information updating unit outputs updated peripheral information that is the peripheral information assigned with the priority by the priority assigning unit.

As a result, the present disclosure further outputs the updated peripheral information in which the peripheral information and the priority for each detection point are integrated, so that it is possible to provide an object detection device that outputs information easily used for processing using the priority.

Furthermore, the present disclosure exhibits the same effect as the above effect by applying the above configuration to the object detection method or the program.

The object detection device of the present disclosure is further configured as follows.

A control determining unit to determine a control content for a vehicle present at a current position by using information indicating certainty relating to the detection point included in the updated peripheral information output by the peripheral information updating unit, and output a control command that commands the control content to a vehicle control device that controls the vehicle is further provided.

As a result, the present disclosure further has an effect of providing an object detection device that controls a vehicle present at a current position on the basis of a highly accurate detection point.

Furthermore, the present disclosure exhibits the same effect as the above effect by applying the above configuration to the object detection method or the program.

### Second Embodiment

In a second embodiment, the embodiment in which a result of sensing the periphery of the current position by each of a plurality of sensors is used will be described.

In the description of the second embodiment, description similar to the content already described will be appropriately omitted.

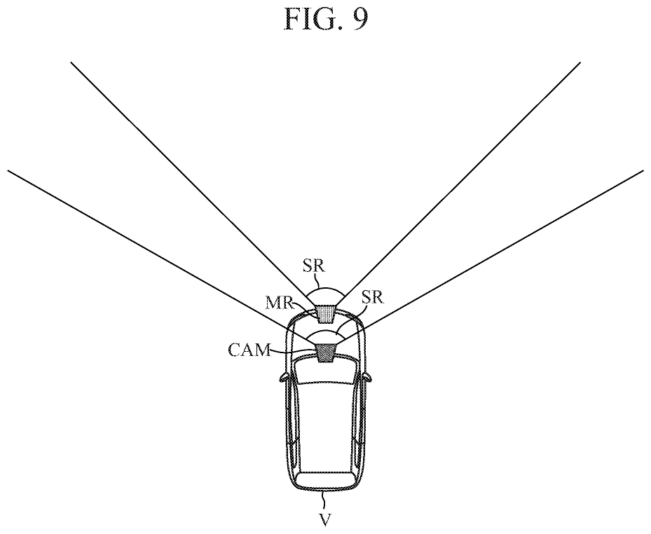

FIG. 9 is a diagram for describing an example of a periphery detection sensor 210 that detects a periphery in the second embodiment.

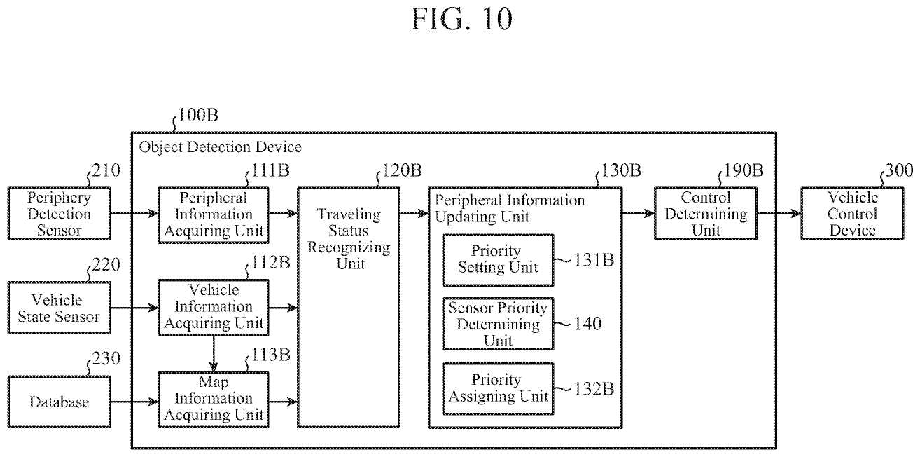

FIG. 10 is a diagram illustrating an example of a configuration of an object detection device 100B and its peripheral devices according to the second embodiment of the present disclosure.

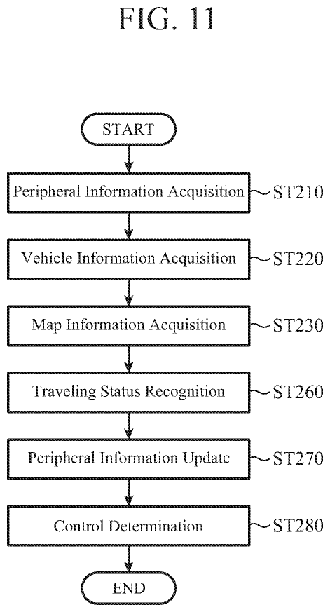

FIG. 11 is a flowchart illustrating an example of processing of the object detection device 100B according to the second embodiment of the present disclosure.

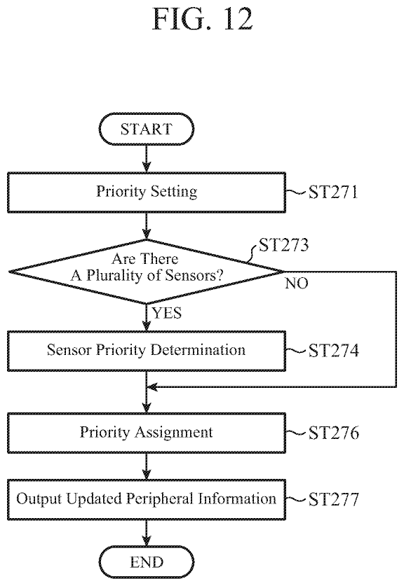

FIG. 12 is a flowchart illustrating an example of processing by a peripheral information updating unit 130B according to the second embodiment.

The object detection device 100B illustrated in FIG. 10 is communicably connected to the periphery detection sensor 210, the vehicle state sensor 220, and the database 230.

For example, as illustrated in FIG. 9, the periphery detection sensor 210 in FIG. 10 is a peripheral detection sensor group including a plurality of types of periphery detection sensors 210 such as a millimeter wave radar “MR” and an in-vehicle camera “CAM”.

Each of the periphery detection sensors 210 in the periphery detection sensor group is similar to the periphery detection sensor 210 described above, and thus a more detailed description thereof will be omitted here.

Since the vehicle state sensor 220 and the database 230 are similar to the vehicle state sensor 220 and the database 230 described above, detailed description thereof is omitted here.

The object detection device 100B includes a peripheral information acquiring unit 111B, a vehicle information acquiring unit 112B, a map information acquiring unit 113B, a traveling status recognizing unit 120B, a peripheral information updating unit 130B, a control determining unit 190B, a control unit (not illustrated), and a storage unit (not illustrated).

The peripheral information acquiring unit 111B acquires peripheral information including detection information for each detection point detected by each of the plurality of sensors.

The vehicle information acquiring unit 112B is similar to the vehicle information acquiring unit 112A described above, and a detailed description thereof will be omitted here.

The map information acquiring unit 113B is similar to the map information acquiring unit 113A described above, and a detailed description thereof will be omitted here.

The traveling status recognizing unit 120B is similar to the traveling status recognizing unit 120A described above, and a detailed description thereof will be omitted here.

The peripheral information updating unit 130B outputs a priority that is information indicating the certainty relating to the detection point by using the first priority and the second priority.

The peripheral information updating unit 130B includes a priority setting unit 131B, a priority assigning unit 132B, and a sensor priority determining unit 140.

The priority setting unit 131B is similar to the priority setting unit 131A described above, and a detailed description thereof will be omitted here.

The sensor priority determining unit 140 uses the vehicle information, the map information, and the traveling status information to determine the second priority for each sensor that outputs the detection information included in the peripheral information. The sensor priority determining unit 140 determines the second priority from the viewpoint of the possibility that the detection point can be detected for each sensor.

The second priority is a value for weighting the detection information for each sensor.

The priority assigning unit 132B assigns a priority, which is information indicating the certainty relating to the detection point, to peripheral information for each detection point and outputs the peripheral information.

Specifically, for example, using the first priority and the second priority, the priority assigning unit 132B assigns a priority, which is information indicating the certainty relating to the detection point, to peripheral information for each detection point, and outputs the updated peripheral information, which is the peripheral information assigned with the priority.

Similarly to the control determining unit 190A described above, the control determining unit 190B determines the control content regarding the detection point for the vehicle present at the current position by using the information indicating the certainty relating to the detection point included in the updated peripheral information output by the peripheral information updating unit 130B, and outputs a control command that commands the control content to the vehicle control device 300 that controls the vehicle.

The control unit (not illustrated) and the storage unit (not illustrated) are similar to the control unit and the storage unit that have already been described, and a detailed description thereof will be omitted here.

The processing of the object detection device 100B will be described with reference to FIGS. 11 and 12.

When starting the processing illustrated in FIG. 11, the object detection device 100B first executes peripheral information acquisition processing (step ST210).

In the peripheral information acquisition processing, similarly to the peripheral information acquiring unit 111A described above, the peripheral information acquiring unit 111B in the object detection device 100B acquires peripheral information including detection information for each detection point detected by sensing the periphery of the current position.

In addition, the peripheral information acquiring unit 111B acquires the peripheral information including detection information for each detection point detected by each of the plurality of sensors. Specifically, the peripheral information acquiring unit 111B acquires, for example, peripheral information including detection information for each detection point by the periphery detection sensors 210 of the group of the periphery detection sensors 210.

The object detection device 100B executes vehicle information acquisition processing (step ST220).

In the vehicle information acquisition processing, the vehicle information acquiring unit 112B in the object detection device 100B acquires the vehicle information including a current position and a state of the vehicle present at the current position, similarly to the vehicle information acquiring unit 112A described above.

Specifically, for example, the vehicle information acquiring unit 112B acquires vehicle information including a current position and a state of the host vehicle (the position and state of the vehicle present at the current position) output from the vehicle state sensors 220 constituting the vehicle state sensor group.

The object detection device 100B executes map information acquisition processing (step ST230).

In the map information acquisition processing, the map information acquiring unit 113B in the object detection device 100B acquires map information including a peripheral area of the current position similarly to the map information acquiring unit 113A described above.

Specifically, for example, the map information acquiring unit 113B acquires vehicle information from the vehicle information acquiring unit 112B, and acquires peripheral map information based on the current position included in the vehicle information from the database 230.

The object detection device 100B executes traveling status recognition processing (step ST260).

In the traveling status recognition processing, similarly to the traveling status recognizing unit 120A described above, the traveling status recognizing unit 120B in the object detection device 100B outputs the traveling status information indicating the traveling state of the vehicle present at the current position and the status around the vehicle by using the peripheral information, the vehicle information, and the map information.

The object detection device 100B executes peripheral information update processing (step ST270).

In the peripheral information update processing, the peripheral information updating unit 130B in the object detection device 100B outputs information indicating the certainty relating to the detection point for each detection point by using the traveling status information.

The peripheral information updating unit 130B sets the first priority or the second priority for each detection point in the peripheral area of the current position by using the traveling status information, and outputs a priority which is information indicating the certainty relating to the detection point for each detection point by using at least the first priority or the second priority.

A specific example of the peripheral information update processing will be described with reference to FIG. 12.

The peripheral information updating unit 130B executes priority setting processing (step ST271).

In the priority setting processing, the priority setting unit 131B in the object detection device 100B sets the first priority for each detection point in the peripheral area of the current position by using the traveling status information, similarly to the priority setting unit 131A described above. The priority setting unit 131B outputs first priority information indicating the first priority.

The peripheral information updating unit 130B determines whether there are a plurality of sensors (step ST273).

Specifically, the sensor priority determining unit 140 in the object detection device 100B determines whether there are a plurality of (two or more kinds, or two or more) periphery detection sensors 210 by using, for example, sensor identification information included in detection information of peripheral information acquired by the peripheral information acquiring unit 111B. Alternatively, the sensor priority determining unit 140 may determine whether there are a plurality of periphery detection sensors 210 by using information related to the periphery detection sensors 210 stored in advance in a storage unit (not illustrated) or the like.

The peripheral information updating unit 130B, when determining that there is no plurality of sensors (step ST273 “NO”), proceeds to processing of step ST275.

The peripheral information updating unit 130B, when determining that there are a plurality of sensors (step ST273 “YES”), executes sensor priority determination processing (step ST274).

In the sensor priority determination processing, the sensor priority determining unit 140 in the object detection device 100B acquires the vehicle information acquired by the vehicle information acquiring unit 112B. At this time, the sensor priority determining unit 140 can directly acquire the vehicle information from the vehicle information acquiring unit 112B, or can acquire the vehicle information via the traveling status recognizing unit 120B.

The sensor priority determining unit 140 acquires the map information acquired by the map information acquiring unit 113B. The map information can be directly acquired from the map information acquiring unit 113B, or the map information can be acquired via the traveling status recognizing unit 120B.

The sensor priority determining unit 140 acquires the traveling status information output by the traveling status recognizing unit 120B.

The sensor priority determining unit 140 uses the vehicle information, the map information, and the traveling status information to determine the second priority for each sensor that outputs the detection information included in the peripheral information.

For example, in a case where one radar sensor using a millimeter wave radar and one imaging sensor using a camera are used as the periphery detection sensors 210, the sensor priority determining unit 140 determines the second priority indicating the certainty relating to detection for each sensor according to the traveling status for each of the detection point detected by the radar sensor and the detection point detected by the imaging sensor. In this case, for example, in a case where the current position is in a dark place, the sensor priority determining unit 140 determines a priority lower than the priority of the detection point by the radar sensor for the detection point by the imaging sensor. Furthermore, the sensor priority determining unit 140 can also determine the priority from the viewpoint of the possibility that the position of the detection point can be detected for each sensor, for example, by further using the installation position, the sensing direction, or the sensing range for each sensor.

Note that, for example, in a case where the number of types of the periphery detection sensors 210 is one and the number of the periphery detection sensors 210 is two or more, such as a case where the sensors in the group of the periphery detection sensors 210 are millimeter wave radars of the same type, the sensor priority determining unit 140 may determine the priority depending on the traveling status for each sensor.

The sensor priority determining unit 140 outputs priority information indicating the second priority for each detection point. Since the second priority for each detection point is determined for each sensor, a plurality of second priorities may be included for each detection point even for detection points at the same position. In this case, the plurality of second priorities for the detection points at the same position may be different values or may be the same value.

The priority information indicating the second priority may be described as “second priority information” in order to be distinguished from the priority information indicating the priority other than the second priority in the description.

The peripheral information updating unit 130B executes priority assignment processing (step ST276).

In the priority assignment processing, the priority assigning unit 132B in the peripheral information updating unit 130B assigns a priority, which is information indicating the certainty relating to the detection point for each detection point, to peripheral information and outputs the peripheral information.

Specifically, for example, the priority assigning unit 132B receives the first priority information from the priority setting unit 131B and acquires the first priority, and receives the second priority information from the sensor priority determining unit 140 and acquires the second priority. As a result, the priority assigning unit 132B obtains only the first priority, only the second priority, or both the first priority and the second priority for each detection point. The priority assigning unit 132B uses at least one of the first priority and the second priority to assign a priority, which is information indicating the certainty relating to the detection point, to peripheral information for each detection point, and outputs the updated peripheral information, which is the peripheral information assigned with the priority.

The priority assigning unit 132B determines a final priority for each detection point indicating each target.

The priority assigning unit 132B determines a detection point of a priority that does not satisfy a predetermined criterion, and deletes the detection point so as not to be included in information to be output. The priority assigning unit 132B deletes a detection point at which both of the first priority and the second priority do not exceed threshold values so as not to be included in the information to be output, for example, the detection point not satisfying a criterion such as a detection point at which both of the first priority and the second priority are equal to or greater than threshold values or a detection point at which either of the first priority and the second priority is equal to or greater than a threshold value.

Further, the priority assigning unit 132B may apply normalization processing for generating a variation in priority to the priorities of all the detection targets. As a result, the priority assigning unit 132B performs final adjustment on the priority so as to be easily used in the control determining unit 190B in the subsequent stage. Note that the present disclosure can be implemented even if the final adjustment method is not limited thereto.

The peripheral information updating unit 130B outputs the updated peripheral information (step ST277).

The peripheral information updating unit 130B outputs the updated peripheral information, which is the peripheral information assigned with the priority for each detection point, to the control determining unit 190B.

When the peripheral information updating unit 130B outputs the updated peripheral information, the processing ends.

Upon completion of the processing, the peripheral information updating unit 130B waits for the start of the next processing.

The description returns to FIG. 11.

The object detection device 100B executes control determination processing (step ST280).

Specifically, similarly to the control determining unit 190A described above, the control determining unit 190B in the object detection device 100B determines the control content for the vehicle present at the current position using the information indicating the certainty relating to the detection point included in the updated peripheral information output by the peripheral information updating unit 130B. The control determining unit 190B outputs a control command that commands the control content to the vehicle control device 300 that controls the vehicle.

While the periphery of the current position is sensed, the object detection device 100B repeatedly executes the processing from step ST210 to step ST280.

The object detection device of the present disclosure is further configured as follows.

The peripheral information acquiring unit acquires the peripheral information including detection information for each of detection points detected by each of a plurality of sensors,
the peripheral information updating unit includes a sensor priority determining unit to determine a second priority for each of sensors that output detection information included in the peripheral information by using the vehicle information, the map information, and the traveling status information, and
the peripheral information updating unit outputs the priority that is information indicating certainty relating to the detection point by using the first priority and the second priority.

As a result, the present disclosure further has an effect of providing an object detection device capable of using a more appropriate detection result from among detection results obtained by a plurality of sensors according to a traveling status.

Furthermore, the present disclosure exhibits the same effect as the above effect by applying the above configuration to the object detection method or the program.

### Third Embodiment

In a third embodiment, the embodiment for adjusting priority will be described.

In the description of the third embodiment, description similar to the content already described will be appropriately omitted.

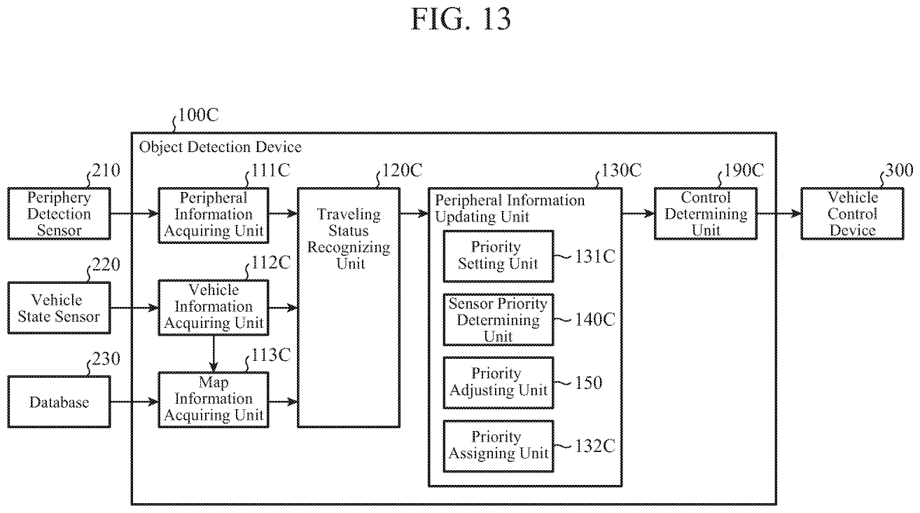

FIG. 13 is a diagram illustrating an example of a configuration of an object detection device 100C and its peripheral devices according to the third embodiment of the present disclosure.

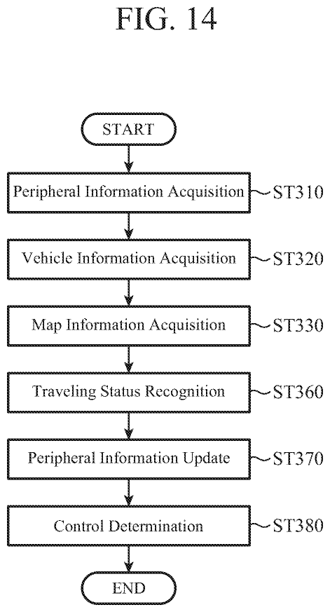

FIG. 14 is a flowchart illustrating an example of processing of the object detection device 100C according to the third embodiment of the present disclosure.

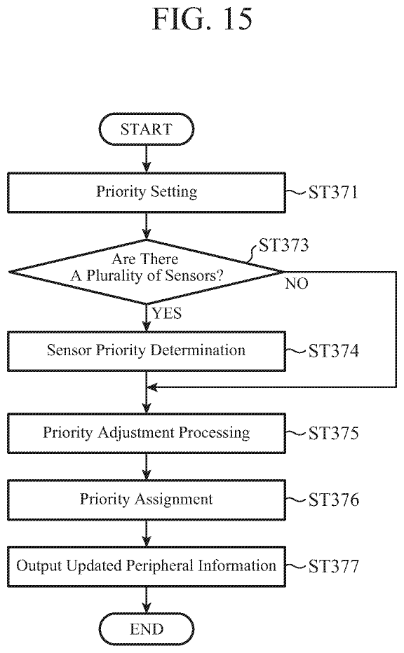

FIG. 15 is a flowchart illustrating an example of processing by a peripheral information updating unit 130C according to the third embodiment.

The object detection device 100C illustrated in FIG. 13 is communicably connected to the periphery detection sensor 210, the vehicle state sensor 220, and the database 230.

The periphery detection sensor 210, the vehicle state sensor 220, and the database 230 are similar to the periphery detection sensor 210, the vehicle state sensor 220, and the database 230 already described in the second embodiment, respectively, and thus, detailed description thereof is omitted here.

The object detection device 100C includes a peripheral information acquiring unit 111C, a vehicle information acquiring unit 112C, a map information acquiring unit 113C, a traveling status recognizing unit 120C, a peripheral information updating unit 130C, a control determining unit 190C, a control unit (not illustrated), and a storage unit (not illustrated).

The peripheral information acquiring unit 111C, the vehicle information acquiring unit 112C, the map information acquiring unit 113C, and the traveling status recognizing unit 120C are similar to the peripheral information acquiring unit 111B, the vehicle information acquiring unit 112B, the map information acquiring unit 113B, and the traveling status recognizing unit 120B already described in the second embodiment, respectively, and thus detailed description thereof is omitted here.

The peripheral information updating unit 130C is different from the peripheral information updating unit 130B described above in that the first priority and the second priority are used.

The peripheral information updating unit 130C includes a priority setting unit 131C, a priority assigning unit 132C, a sensor priority determining unit 140C, and a priority adjusting unit 150.

The priority setting unit 131C and the sensor priority determining unit 140C are similar to the priority setting unit 131B and the sensor priority determining unit 140 described above, respectively, and thus detailed description thereof is omitted here.

The priority adjusting unit 150 adjusts a priority for each detection point on the basis of the acquired information and outputs the adjusted priority.

The priority adjusting unit 150 uses the first priority and the second priority, and outputs a priority that is information indicating certainty relating to the detection point on the basis of the first priority or the second priority.

Alternatively, the priority adjusting unit 150 uses the first priority and the second priority, and outputs a priority that is information indicating certainty relating to the detection point on the basis of the first priority and the second priority.

The priority assigning unit 132C assigns a priority, which is information indicating the certainty relating to the detection point, to peripheral information for each detection point and outputs the peripheral information.

Specifically, for example, the priority assigning unit 132C assigns the priority adjusted by the priority adjusting unit 150 using the first priority and the second priority to the peripheral information, and outputs the updated peripheral information which is the peripheral information assigned with the priority.

Since the control determining unit 190C is similar to the control determining unit 190B described above, a detailed description thereof will be omitted here.

The control unit (not illustrated) and the storage unit (not illustrated) are similar to the control unit and the storage unit that have already been described, and a detailed description thereof will be omitted here.

The processing of the object detection device 100C will be described with reference to FIGS. 14 and 15.

The object detection device C, when starting the processing illustrated in FIG. 14, first executes peripheral information acquisition processing (step ST310).

In the peripheral information acquisition processing, the peripheral information acquiring unit 111C in the object detection device 100C acquires peripheral information including detection information for each detection point detected by sensing the periphery of the current position, similarly to the peripheral information acquiring unit 111A, B described above.

In addition, the peripheral information acquiring unit 111C acquires the peripheral information including detection information for each detection point detected by each of the plurality of sensors. Specifically, for example, the peripheral information acquiring unit 111C acquires peripheral information including detection information for each detection point by the periphery detection sensors 210 of the group of the peripheral detection sensors 210.

The object detection device 100C executes vehicle information acquisition processing (step ST320).

In the vehicle information acquisition processing, the vehicle information acquiring unit 112C in the object detection device 100C acquires the vehicle information including a current position and a state of the vehicle present at the current position, similarly to the vehicle information acquiring unit 112A, B described above.

Specifically, for example, the vehicle information acquiring unit 112C acquires vehicle information including the current position and state of the host vehicle (the position and state of the vehicle present at the current position) output from the vehicle state sensors 220 constituting the vehicle state sensor group.

The object detection device 100C executes map information acquisition processing (step ST330).

In the map information acquisition processing, the map information acquiring unit 113C in the object detection device 100C acquires map information including a peripheral area of the current position similarly to the map information acquiring unit 113A, B described above.

Specifically, for example, the map information acquiring unit 113C acquires vehicle information from the vehicle information acquiring unit 112C, and acquires peripheral map information based on the current position included in the vehicle information from the database 230.

For example, as illustrated in FIG. 6, the map information acquiring unit 113C acquires map information indicating a peripheral area of a current position by accessing the database 230 as needed via the Internet using position information indicating the current position of the host vehicle.

Alternatively, for example, the map information acquiring unit 113C acquires map information indicating a peripheral area of the current position by accessing a memory in which the map information is stored in advance as needed.

The timing of acquiring the map information may be, for example, every time the current position is acquired or every fixed time interval.

The object detection device 100C executes traveling status recognition processing (step ST360).

In the traveling status recognition processing, the traveling status recognizing unit 120C in the object detection device 100C outputs the traveling status information indicating the traveling status of the vehicle present at the current position and the status around the vehicle by using the peripheral information, the vehicle information, and the map information, similarly to the traveling status recognizing unit 120A, B described above.

The object detection device 100C executes peripheral information update processing (step ST370).

In the peripheral information update processing, the peripheral information updating unit 130C in the object detection device 100C outputs information indicating the certainty relating to the detection point for each detection point by using the traveling status information.

The peripheral information updating unit 130C sets the first priority or the second priority for each detection point in the peripheral area of the current position by using the traveling status information, and outputs the priority which is information indicating the certainty relating to the detection point for each detection point by using at least the first priority or the second priority.

A specific example of the peripheral information update processing will be described with reference to FIG. 15.

The peripheral information updating unit 130C executes priority setting processing (step ST371).

In the priority setting processing, the priority setting unit 131C in the object detection device 100C sets the first priority for each detection point in the peripheral area of the current position by using the traveling status information. The priority setting unit 131C outputs first priority information indicating the first priority.

The peripheral information updating unit 130C determines whether there are a plurality of sensors (step ST373).

Specifically, the sensor priority determining unit 140C in the object detection device 100C determines whether there are a plurality of (two or more kinds, or two or more) periphery detection sensors 210 by using, for example, sensor identification information included in detection information of peripheral information acquired by the peripheral information acquiring unit 111C. Alternatively, the sensor priority determining unit 140C may determine whether there are a plurality of periphery detection sensors 210 by using information related to the periphery detection sensors 210 stored in advance in a storage unit (not illustrated) or the like.

The peripheral information updating unit 130C, when determining that there is no plurality of sensors (step ST373 “NO”), proceeds to processing of step ST375.

The peripheral information updating unit 130C, when determining that there are a plurality of sensors (step ST373 “YES”), executes sensor priority determination processing (step ST374). In the sensor priority determination processing, the sensor priority determining unit 140C in the peripheral information updating unit 130C executes the sensor priority determination processing and outputs the second priority information, similarly to the sensor priority determination processing by the sensor priority determining unit 140 described above.

The peripheral information updating unit 130C executes priority adjustment processing (step ST375).

In the priority adjustment processing, the priority adjusting unit 150 in the peripheral information updating unit 130C receives the first priority information from the priority setting unit 131C and acquires the first priority. Further, the priority adjusting unit 150 receives the second priority information from the sensor priority determining unit 140C and acquires the second priority.

The priority adjusting unit 150 uses the first priority and the second priority, and outputs a priority that is information indicating certainty relating to the detection point on the basis of the first priority or the second priority. In this case, the priority adjusting unit 150 compares, for example, the first priority with the second priority to determine either of them, and calculates a priority based on the first priority or the second priority.

Alternatively, the priority adjusting unit 150 uses the first priority and the second priority, and outputs a priority that is information indicating certainty relating to the detection point on the basis of the first priority and the second priority. In this case, for example, the priority adjusting unit 150 calculates a priority obtained by adding the second priority to the first priority for the detection point at which both the first priority and the second priority are equal to or greater than the threshold value.

The peripheral information updating unit 130C executes priority assignment processing (step ST376).

In the priority assignment processing, the priority assigning unit 132C in the peripheral information updating unit 130C assigns a priority, which is information indicating the certainty relating to the detection point for each detection point, to peripheral information and outputs the peripheral information.

The priority assigning unit 132C acquires the adjusted priority (priority for each detection point) from the priority adjusting unit 150, and determines the final priority for each detection point indicating each target.

The priority assigning unit 132C determines a detection point of a priority that does not satisfy a predetermined criterion, and deletes the detection point so as not to be included in information to be output. The priority assigning unit 132C deletes a detection point at which both of the first priority and the second priority do not exceed threshold values so as not to be included in the information to be output, for example, the detection point not satisfying a criterion such as a detection point at which both of the first priority and the second priority are equal to or greater than threshold values or a detection point at which either of the first priority and the second priority is equal to or greater than a threshold value.

Further, the priority assigning unit 132C may apply normalization processing for generating a variation in priority to the priorities of all the detection targets. As a result, the priority assigning unit 132C performs final adjustment on the priority so as to be easily used by the control determining unit 190C in the subsequent stage. Note that the present disclosure can be implemented even if the final adjustment method is not limited thereto.

The peripheral information updating unit 130C outputs the updated peripheral information (step ST377).

The peripheral information updating unit 130C outputs, to the control determining unit 190C, the updated peripheral information that is peripheral information assigned with the priority for each detection point adjusted by the priority adjusting unit 150 from the priority assigning unit 132C.

When the peripheral information updating unit 130C outputs the updated peripheral information, the processing ends.

Upon completion of the processing, the peripheral information updating unit 130C waits for the start of the next processing.

The description returns to FIG. 14.

The object detection device 100C executes control determination processing (step ST380).

Specifically, similarly to the control determining unit 190A, B described above, the control determining unit 190C in the object detection device 100C determines the control content for the vehicle present at the current position by using the information indicating the certainty relating to the detection point included in the updated peripheral information output by the peripheral information updating unit 130C. The control determining unit 190C outputs a control command that commands the control content to the vehicle control device 300 that controls the vehicle.

While the periphery of the current position is sensed, the object detection device 100C repeatedly executes the processing from step ST310 to step ST380.

The object detection device of the present disclosure is further configured as follows.

The peripheral information updating unit includes:
a priority adjusting unit to output the priority that is information indicating certainty relating to the detection point on the basis of the first priority or the second priority by using the first priority and the second priority.

As a result, the present disclosure further has an effect that it is possible to provide the object detection device that selects a more appropriate priority from the first priority and the second priority according to the traveling status and uses the selected priority for the information indicating the certainty relating to the detection point.

Furthermore, the present disclosure exhibits the same effect as the above effect by applying the above configuration to the object detection method or the program.

The object detection device of the present disclosure is further configured as follows.

The peripheral information updating unit includes:
a priority adjusting unit to output the priority that is information indicating certainty relating to the detection point on the basis of the first priority and the second priority by using the first priority and the second priority.

As a result, the present disclosure further has an effect that it is possible to provide the object detection device that uses the first priority and the second priority for the information indicating the certainty relating to the detection point according to the traveling status.

Furthermore, the present disclosure exhibits the same effect as the above effect by applying the above configuration to the object detection method or the program.

### Fourth Embodiment

In a fourth embodiment, the embodiment in which the priority for each detection point is easily determined will be described.

In the description of the fourth embodiment, description similar to the content already described will be appropriately omitted.

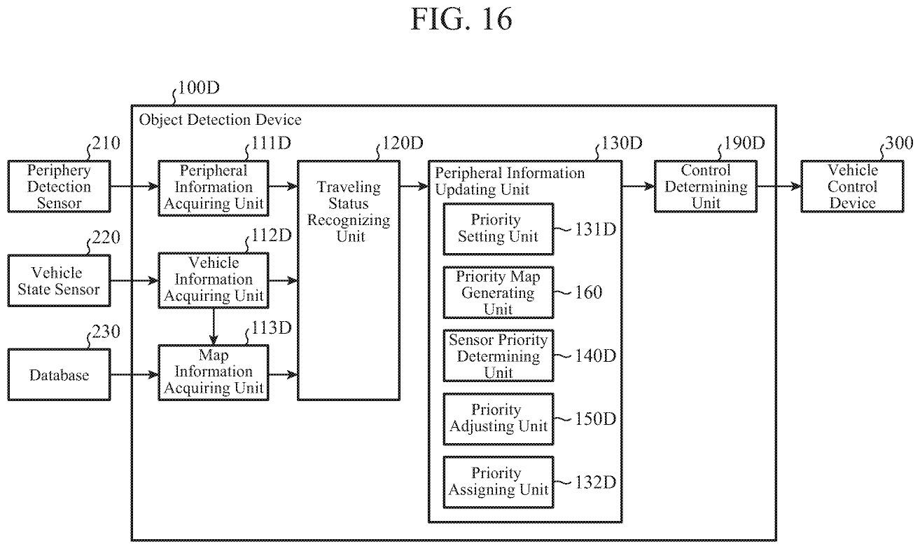

FIG. 16 is a diagram illustrating an example of a configuration of an object detection device 100D and its peripheral devices according to the fourth embodiment of the present disclosure.

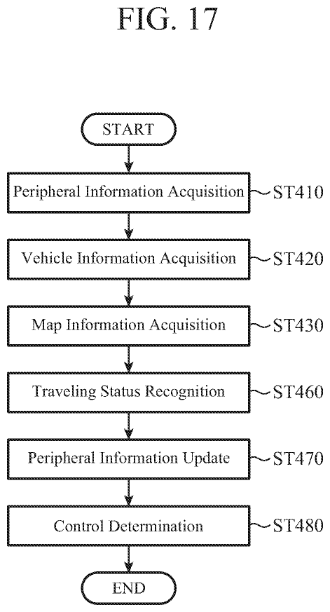

FIG. 17 is a flowchart illustrating an example of processing of the object detection device 100D according to the fourth embodiment of the present disclosure.

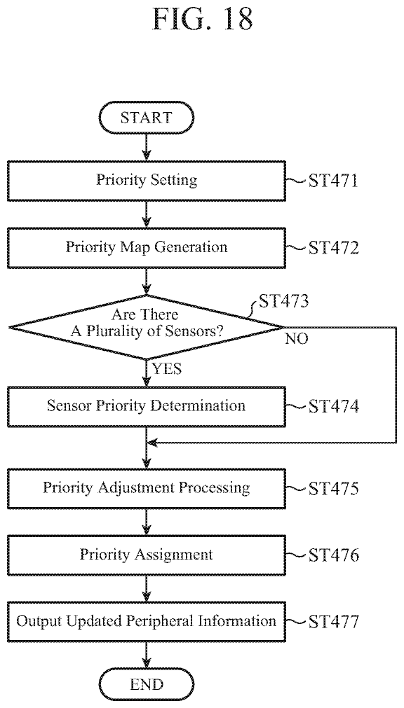

FIG. 18 is a flowchart illustrating an example of processing by a peripheral information updating unit 130D according to the fourth embodiment.

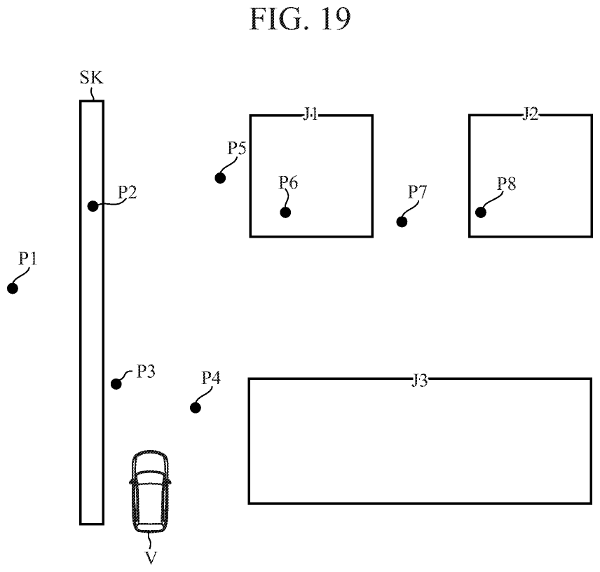

FIG. 19 is a first diagram for describing a priority map according to the fourth embodiment.

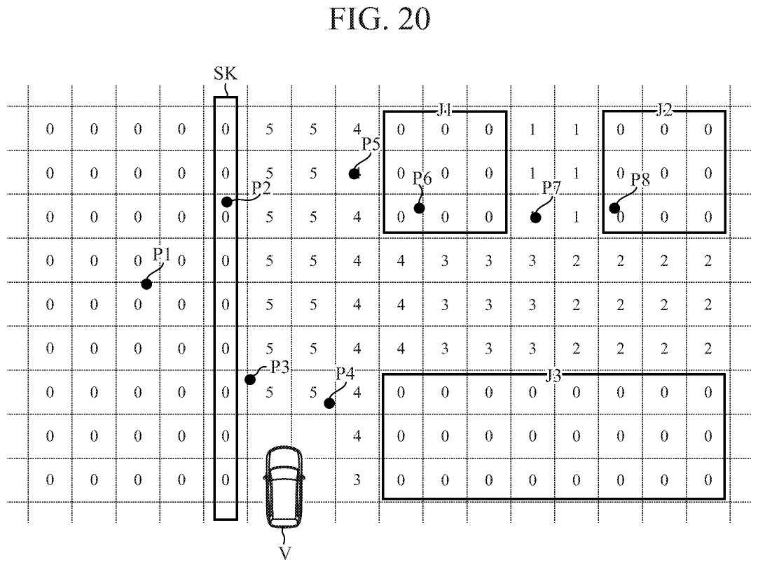

FIG. 20 is a second diagram for describing the priority map according to the fourth embodiment.

The object detection device 100D illustrated in FIG. 16 is communicably connected to the periphery detection sensor 210, the vehicle state sensor 220, and the database 230.

The periphery detection sensor 210, the vehicle state sensor 220, and the database 230 are similar to the periphery detection sensor 210, the vehicle state sensor 220, and the database 230 described above, respectively, and thus, detailed description thereof is omitted here.

The object detection device 100D includes a peripheral information acquiring unit 111D, a vehicle information acquiring unit 112D, a map information acquiring unit 113D, a traveling status recognizing unit 120D, a peripheral information updating unit 130D, a control determining unit 190D, a control unit (not illustrated), and a storage unit (not illustrated).

The peripheral information acquiring unit 111D, the vehicle information acquiring unit 112D, the map information acquiring unit 113D, and the traveling status recognizing unit 120D are similar to the peripheral information acquiring unit 111C, the vehicle information acquiring unit 112C, the map information acquiring unit 113C, and the traveling status recognizing unit 120C that have already been described, and thus detailed description thereof will be omitted here.

The peripheral information updating unit 130D is different from the peripheral information updating unit 130C described above in that the peripheral information updating unit 130D includes a priority map generating unit 160.

The peripheral information updating unit 130D determines, for each detection point, a priority that is information indicating the certainty relating to the detection point using the priority map.

The peripheral information updating unit 130D includes a priority setting unit 131D, a priority assigning unit 132D, a sensor priority determining unit 140D, a priority adjusting unit 150D, and a priority map generating unit 160.

The priority setting unit 131D is similar to the priority setting unit 131A, B, C described above, and a detailed description thereof will be omitted here.

Note that the priority setting unit 131D may be configured to set a priority of the position of the detection point indicated in the priority map as the first priority by using the priority map generated by the following priority map generating unit 160 instead of the configuration of the priority setting unit 131A, B, C described above.

The priority map generating unit 160 generates a priority map indicating the priority for each position of the peripheral area on the basis of the recognition result by the traveling status recognizing unit 120D.

Specifically, the priority map generating unit 160 uses the peripheral information, the map information, the vehicle information, and the traveling status information to generate the priority map indicating the priority for each position included in the peripheral area of the current position.

The sensor priority determining unit 140D is similar to the sensor priority determining unit 140C described above, and a detailed description thereof will be omitted here.

The priority adjusting unit 150D further outputs the priority adjusted using the priority map in addition to the function of the priority adjusting unit 150C described above.

Specifically, for example, the priority adjusting unit 150D further adjusts the level of the priority according to the level of the priority indicated in the priority map, and outputs the adjusted priority.

The priority assigning unit 132D assigns a priority, which is information indicating the certainty relating to the detection point, to peripheral information for each detection point and outputs the peripheral information.

Specifically, the priority assigning unit 132D assigns, to peripheral information, a priority that is information indicating the certainty relating to the detection point for each detection point and is adjusted by the priority adjusting unit 150D, and outputs the updated peripheral information that is the peripheral information assigned with the priority.

The control determining unit 190D is similar to the control determining unit 190A, B, C described above, and a detailed description thereof will be omitted here.

The control unit (not illustrated) and the storage unit (not illustrated) are similar to the control unit and the storage unit that have already been described, and a detailed description thereof will be omitted here.

The processing of the object detection device 100D will be further described with reference to FIGS. 17, 18, 19, and 20.

The object detection device 100D, when starting the processing illustrated in FIG. 17, first executes peripheral information acquisition processing (step ST410).

In the peripheral information acquisition processing, the peripheral information acquiring unit 111D in the object detection device 100D acquires peripheral information including detection information for each detection point detected by sensing the periphery of the current position, similarly to the peripheral information acquiring unit 111A, B, C described above.

In addition, the peripheral information acquiring unit 111D acquires the peripheral information including detection information for each detection point detected by each of the plurality of sensors. Specifically, for example, the peripheral information acquiring unit 111D acquires peripheral information including detection information for each detection point by the periphery detection sensors 210 of the group of the periphery detection sensors 210.

The object detection device 100D executes vehicle information acquisition processing (step ST420).

In the vehicle information acquisition processing, the vehicle information acquiring unit 112D in the object detection device 100D acquires vehicle information including a current position and a state of the vehicle existing at the current position, similarly to the vehicle information acquiring units 112A, B, C described above.

Specifically, for example, the vehicle information acquiring unit 112D acquires vehicle information including the current position and state of the host vehicle (the position and state of the vehicle present at the current position) output from the vehicle state sensors 220 constituting the vehicle state sensor group.

The object detection device 100D executes map information acquisition processing (step ST430).

In the map information acquisition processing, the map information acquiring unit 113D in the object detection device 100D acquires map information including a peripheral area of the current position similarly to the map information acquiring unit 113A, B, C described above.

Specifically, for example, the map information acquiring unit 113D acquires vehicle information from the vehicle information acquiring unit 112D, and acquires peripheral map information based on the current position included in the vehicle information from the database 230.

The object detection device 100D executes traveling status recognition processing (step ST460).

In the traveling status recognition processing, the traveling status recognizing unit 120D in the object detection device 100D outputs the traveling status information indicating the traveling state of the vehicle present at the current position and the status around the vehicle by using the peripheral information, the vehicle information, and the map information, similarly to the traveling status recognizing unit 120A, B, C described above.

The object detection device 100D executes peripheral information update processing (step ST470).

In the peripheral information update processing, the peripheral information updating unit 130D in the object detection device 100D outputs information indicating the certainty relating to the detection point for each detection point by using the traveling status information.

The peripheral information updating unit 130D sets the first priority or the second priority for each detection point in the peripheral area of the current position by using the traveling status information, and outputs a priority which is information indicating the certainty relating to the detection point for each detection point by using at least the first priority or the second priority.

A specific example of the peripheral information update processing will be described with reference to FIG. 18.

The peripheral information updating unit 130D executes priority setting processing (step ST471).

In the priority setting processing, the priority setting unit 131D in the object detection device 100D sets the first priority for each detection point in the peripheral area of the current position by using the traveling status information. The priority setting unit 131D outputs first priority information indicating the first priority.

The peripheral information updating unit 130D executes priority map generation processing (step ST472).

In the priority map generation processing, the priority map generating unit 160 in the object detection device 100D generates the priority map indicating the priority for each position included in the peripheral area of the current position by using the peripheral information, the map information, the vehicle information, and the traveling status information.

A specific example of the priority map will be described.

FIG. 19 shows a diagram in which a map showing a current position where a vehicle (host vehicle) “V” exists and a peripheral area, and detection points indicating targets “P1”, “P2”, “P3”, “P4”, “P5”, “P6”, “P7”, and “P8” detected by peripheral detection sensors 210 are superimposed.

In the priority map illustrated in FIG. 19, a scene is assumed in which a fence “SK” extends forward on the left side of the host vehicle “V” and houses “J1”, “J2”, and “J3” are built on the right side with respect to the host vehicle “V”.

The priority map generating unit 160 generates the priority map as illustrated in FIG. 20 on the basis of the peripheral recognition result as illustrated in FIG. 19 and the detailed information representing the traveling status as illustrated in FIG. 4.

In the priority map illustrated in FIG. 20, the lowest priority “0” is set to an area on the back side of the fence “SK” into which the host vehicle “V” cannot enter and an area inside the houses “J1”, “J2”, and “J3”, the highest priority 5 is mapped on the map to an area corresponding to the traveling direction of the host vehicle “V”, and a medium priority is set to an area where the host vehicle “V” cannot enter unless it turns and enters and an area that is far from the host vehicle.

By including the priority map generating unit 160 that generates such a priority map, the object detection device 100D can easily determine a rough priority for each detection point on the basis of the position information for each detection point.

Note that the priority map described above is an example, and the configuration of the present disclosure can be implemented and the similar effect can be obtained as long as the priority map is a priority map indicating the priority for each position included in the peripheral area of the current position, and the priority map makes it easy to determine the priority for each detection point.

The description returns to FIG. 18.

The peripheral information updating unit 130D determines whether there are a plurality of sensors (step ST473).

Specifically, the sensor priority determining unit 140D in the object detection device 100D determines whether there are a plurality of (two or more kinds, or two or more) periphery detection sensors 210 by using, for example, sensor identification information included in detection information of peripheral information acquired by the peripheral information acquiring unit 111D. Alternatively, the sensor priority determining unit 140D may determine whether there are a plurality of periphery detection sensors 210 by using information related to the periphery detection sensors 210 stored in advance.

The peripheral information updating unit 130D, when determining that there is no plurality of sensors (step ST473 “NO”), proceeds to processing of step ST475.

The peripheral information updating unit 130D, when determining that there are a plurality of sensors (step ST473 “YES”), executes sensor priority determination processing (step ST474).

In the sensor priority determination processing, the sensor priority determining unit 140D in the object detection device 100D acquires the vehicle information acquired by the vehicle information acquiring unit 112D. At this time, the sensor priority determining unit 140D can directly acquire the vehicle information from the vehicle information acquiring unit 112D, or can acquire the vehicle information via the traveling status recognizing unit 120D.

The sensor priority determining unit 140D acquires the map information acquired by the map information acquiring unit 113D. The map information can be directly acquired from the map information acquiring unit 113D, or the map information can be acquired via the traveling status recognizing unit 120D.

The sensor priority determining unit 140D acquires the traveling status information output by the traveling status recognizing unit 120D.

The sensor priority determining unit 140D determines the second priority for each sensor that outputs the detection information included in the peripheral information, using the vehicle information, the map information, and the traveling status information.

The sensor priority determining unit 140D outputs second priority information that is priority information indicating the second priority.

The peripheral information updating unit 130D executes priority adjustment processing (step ST475).

In the priority adjustment processing, the priority adjusting unit 150D in the peripheral information updating unit 130D receives the first priority information from the priority setting unit 131D and acquires the first priority. Further, the priority adjusting unit 150D receives the second priority information from the sensor priority determining unit 140D and acquires the second priority. Further, the priority adjusting unit 150D acquires the traveling status information from the traveling status recognizing unit 120D.

Using the first priority and the second priority, the priority adjusting unit 150D outputs the priority that is information indicating the certainty relating to the detection point on the basis of the first priority or the second priority. In this case, the priority adjusting unit 150D compares, for example, the first priority with the second priority to determine either of them, and calculates the priority based on the first priority or the second priority.

Alternatively, the priority adjusting unit 150D outputs the priority that is the information indicating the certainty relating to the detection point on the basis of the first priority and the second priority by using the first priority and the second priority. In this case, for example, the priority adjusting unit 150D calculates the priority in which the second priority is added to the first priority for the detection point at which both of the first priority and the second priority are equal to or greater than the threshold value.

The peripheral information updating unit 130D executes priority assignment processing (step ST476).

In the priority assignment processing, the priority assigning unit 132D in the peripheral information updating unit 130D assigns a priority, which is information indicating the certainty relating to the detection point for each detection point, to peripheral information and outputs the peripheral information.

The peripheral information updating unit 130D outputs the updated peripheral information (step ST477).

The peripheral information updating unit 130D outputs, to the control determining unit 190D, updated peripheral information that is peripheral information assigned with the priority for each detection point adjusted by the priority adjusting unit 150D.

When the peripheral information updating unit 130D outputs the updated peripheral information, the processing ends.

Upon completion of the processing, the peripheral information updating unit 130D waits for the start of the next processing.

The description returns to FIG. 17.

The object detection device 100D executes control determination processing (step ST480).

Specifically, similarly to the control determining unit 190A, B, C described above, the control determining unit 190D in the object detection device 100D determines the control content for the vehicle present at the current position by using the information indicating the certainty relating to the detection point included in the updated peripheral information output by the peripheral information updating unit 130D. The control determining unit 190D outputs a control command that commands the control content to the vehicle control device 300 that controls the vehicle.

While the periphery of the current position is sensed, the object detection device 100D repeatedly executes the processing from step ST410 to step ST480.

The object detection device of the present disclosure is further configured as follows.

The peripheral information updating unit includes:
a priority map generating unit to generate a priority map indicating a priority for each of positions included in a peripheral area of a current position by using the peripheral information, the map information, the vehicle information, and the traveling status information, and
the peripheral information updating unit determines, for each of the detection points, the priority that is information indicating certainty relating to the detection point by using the priority map.

As a result, the present disclosure further has an effect that it is possible to provide the object detection device that can easily determine the priority for each detection point.

Furthermore, the present disclosure exhibits the same effect as the above effect by applying the above configuration to the object detection method or the program.

### Fifth Embodiment

In a fifth embodiment, the embodiment for adjusting the priority for each detection point using the second priority that is the priority of the sensor will be described.

In the description of the fifth embodiment, description similar to the content already described will be appropriately omitted.

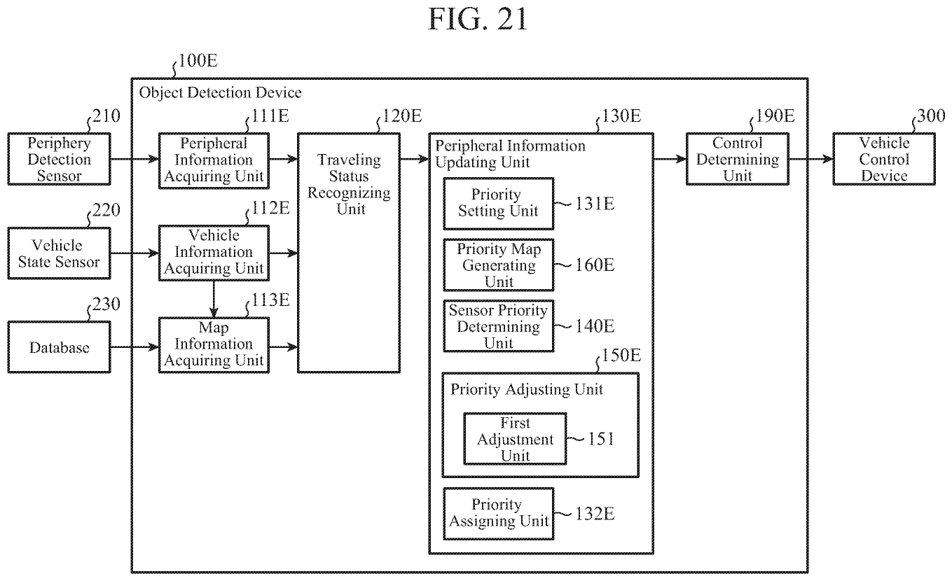

FIG. 21 is a diagram illustrating an example of a configuration of an object detection device 100E and its peripheral devices according to the fifth embodiment of the present disclosure.

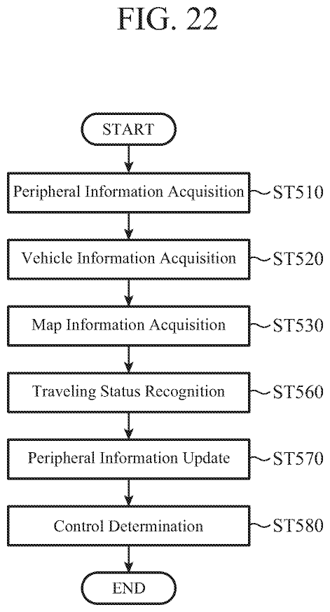

FIG. 22 is a flowchart illustrating an example of processing of the object detection device 100E according to the fifth embodiment of the present disclosure.

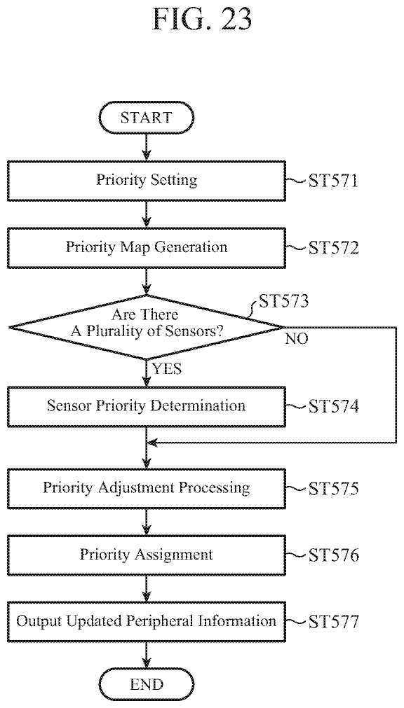

FIG. 23 is a flowchart illustrating an example of processing by a peripheral information updating unit 130E according to the fifth embodiment.

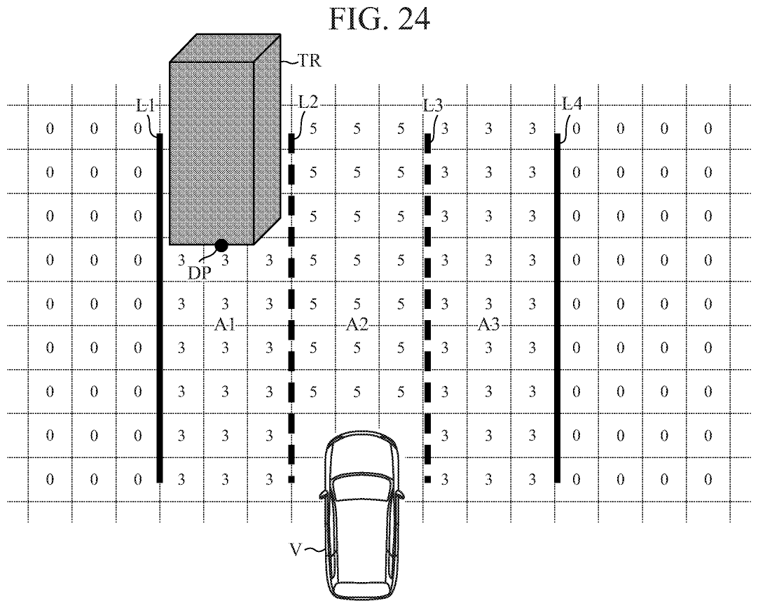

FIG. 24 is a first diagram for describing priority adjustment processing according to the fifth embodiment.

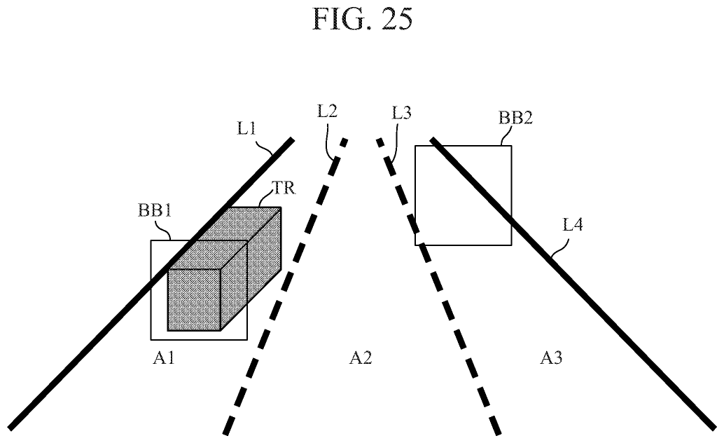

FIG. 25 is a second diagram for describing the priority adjustment processing according to the fifth embodiment.

The object detection device 100E illustrated in FIG. 21 is communicably connected to the periphery detection sensor 210, the vehicle state sensor 220, and the database 230.

The periphery detection sensor 210, the vehicle state sensor 220, and the database 230 are similar to the periphery detection sensor 210, the vehicle state sensor 220, and the database 230 described above, respectively, and thus, detailed description thereof is omitted here.

The object detection device 100E includes a peripheral information acquiring unit 111E, a vehicle information acquiring unit 112E, a map information acquiring unit 113E, a traveling status recognizing unit 120E, a peripheral information updating unit 130E, a control determining unit 190E, a control unit (not illustrated), and a storage unit (not illustrated).

The peripheral information acquiring unit 111E, the vehicle information acquiring unit 112E, the map information acquiring unit 113E, and the traveling status recognizing unit 120E are similar to the peripheral information acquiring unit 111D, the vehicle information acquiring unit 112D, the map information acquiring unit 113D, and the traveling status recognizing unit 120D described above, respectively, and a detailed description thereof will be omitted here.

The peripheral information updating unit 130E includes a priority setting unit 131E, a priority map generating unit 160E, a sensor priority determining unit 140E, a priority adjusting unit 150E, and a priority assigning unit 132E.

The priority setting unit 131E, the priority map generating unit 160E, and the sensor priority determining unit 140E are similar to the priority setting unit 131D, the priority map generating unit 160, and the sensor priority determining unit 140D described above, respectively, and detailed description thereof is omitted here.

The priority adjusting unit 150E is different from the priority adjusting unit 150D described above in that the priority adjusting unit 150E has a function of performing adjustment using the second priority in addition to the function of the priority adjusting unit 150D described above.

The priority adjusting unit 150E includes a first adjustment unit 151.

The first adjustment unit 151 adjusts the priority, which is information indicating the certainty relating to the detection point for each detection point by using the second priority and outputs the adjusted priority.

The priority assigning unit 132E assigns a priority, which is information indicating the certainty relating to the detection point, to peripheral information for each detection point and outputs the peripheral information.

Specifically, the priority assigning unit 132E assigns, to the peripheral information, a priority after adjustment adjusted by the priority adjusting unit 150E, which is a priority that is information indicating the certainty relating to the detection point for each detection point, and outputs the updated peripheral information that is the peripheral information assigned with the priority.

The control determining unit 190E is similar to the control determining unit 190A, B, C, D described above, and a detailed description thereof will be omitted here.

The control unit (not illustrated) and the storage unit (not illustrated) are similar to the control unit and the storage unit that have already been described, and a detailed description thereof will be omitted here.

That is, the priority adjusting unit 150E in the object detection device 100E includes the first adjustment unit 151 that adjusts the priority that is the information indicating the certainty relating to the detection point for each detection point by using the second priority and outputs the adjusted priority.

The processing of the object detection device 100E will be described with reference to FIGS. 22, 23, 24, and 25.

The object detection device 100E, when starting the processing illustrated in FIG. 22, first executes peripheral information acquisition processing (step ST510).

In the peripheral information acquisition processing, the peripheral information acquiring unit 111E in the object detection device 100E acquires peripheral information including detection information for each detection point detected by sensing the periphery of the current position, similarly to the peripheral information acquiring unit 111A, B, C, D described above.

In addition, the peripheral information acquiring unit 111E acquires the peripheral information including detection information for each detection point detected by each of the plurality of sensors. Specifically, the peripheral information acquiring unit 111E acquires, for example, peripheral information including detection information for each detection point by the periphery detection sensors 210 of the group of the periphery detection sensors 210.

The object detection device 100E executes vehicle information acquisition processing (step ST520).

In the vehicle information acquisition processing, the vehicle information acquiring unit 112E in the object detection device 100E acquires the vehicle information including a current position and a state of the vehicle present at the current position, similarly to the vehicle information acquiring unit 112A, B, C, D described above.

Specifically, the vehicle information acquiring unit 112E acquires, for example, vehicle information including the current position and state of the host vehicle (the position and state of the vehicle present at the current position) output from the vehicle state sensors 220 constituting the vehicle state sensor group.

The object detection device 100E executes map information acquisition processing (step ST530).

In the map information acquisition processing, the map information acquiring unit 113E in the object detection device 100E acquires map information including a peripheral area of the current position similarly to the map information acquiring unit 113A, B, C, D described above.

Specifically, for example, the map information acquiring unit 113E acquires vehicle information from the vehicle information acquiring unit 112E, and acquires peripheral map information based on the current position included in the vehicle information from the database 230.

The object detection device 100E executes a traveling status recognition processing (step ST560).

In the traveling status recognition processing, similarly to the already described traveling status recognizing unit 120A, B, C, D, the traveling status recognizing unit 120E in the object detection device 100E outputs the traveling status information indicating the traveling status of the vehicle present at the current position and the status around the vehicle by using the peripheral information, the vehicle information, and the map information.

The object detection device 100E executes peripheral information update processing (step ST570).

In the peripheral information update processing, the peripheral information updating unit 130E in the object detection device 100E outputs information indicating the certainty relating to the detection point for each detection point by using the traveling status information.

The peripheral information updating unit 130E sets the first priority or the second priority for each detection point in the peripheral area of the current position by using the traveling status information, and outputs the priority, which is information indicating the certainty relating to the detection point for each detection point, by using at least the first priority or the second priority.

A specific example of the peripheral information update processing will be described with reference to FIG. 23.

The peripheral information updating unit 130E executes priority setting processing (step ST571).

In the priority setting processing, the priority setting unit 131E in the object detection device 100E sets the first priority for each detection point in the peripheral area of the current position by using the traveling status information. The priority setting unit 131E outputs first priority information indicating the first priority.

The peripheral information updating unit 130E executes priority map generation processing (step ST572).

In the priority map generation processing, the priority map generating unit 160E in the object detection device E generates the priority map indicating the priority for each position included in the peripheral area of the current position by using the peripheral information, the map information, the vehicle information, and the traveling status information.

The peripheral information updating unit 130E determines whether there are a plurality of sensors (step ST573).

Specifically, the sensor priority determining unit 140E in the object detection device 100E determines whether there are a plurality of (two or more kinds, or two or more) periphery detection sensors 210, for example, by using sensor identification information included in detection information of peripheral information acquired by the peripheral information acquiring unit 111E. Alternatively, the sensor priority determining unit 140E may determine whether there are a plurality of periphery detection sensors 210 by using information related to the periphery detection sensors 210 stored in advance in a storage unit (not illustrated) or the like.

The peripheral information updating unit 130E, when determining that there is no plurality of sensors (step ST573 “NO”), proceeds to processing of step ST575.

The peripheral information updating unit 130E, when determining that there are a plurality of sensors (step ST573 “YES”), executes sensor priority determination processing (step ST574).

In the sensor priority determination processing, the sensor priority determining unit 140E in the object detection device 100E acquires the vehicle information acquired by the vehicle information acquiring unit 112E. At this time, the sensor priority determining unit 140E can directly acquire the vehicle information from the vehicle information acquiring unit 112E, or can acquire the vehicle information via the traveling status recognizing unit 120E.

The sensor priority determining unit 140E acquires the map information acquired by the map information acquiring unit 113E. The map information can be directly acquired from the map information acquiring unit 113E, or the map information can be acquired via the traveling status recognizing unit 120E.

The sensor priority determining unit 140E acquires the traveling status information output by the traveling status recognizing unit 120E.

The sensor priority determining unit 140E determines the second priority for each sensor that outputs the detection information included in the peripheral information, by using the vehicle information, the map information, and the traveling status information.

For example, when one radar sensor using a millimeter wave radar and one imaging sensor using a camera are used as the periphery detection sensor 210, the sensor priority determining unit 140E determines the second priority indicating the certainty relating to the traveling status for each of the detection point detected by the radar sensor and the detection point detected by the imaging sensor.

Note that, for example, in a case where the number of types of the periphery detection sensors 210 is one and the number of the periphery detection sensors 210 is two or more, such as a case where the sensors in the group of the periphery detection sensors are millimeter wave radars of the same type, the sensor priority determining unit 140E may determine the priority depending on the traveling status for each sensor.

The sensor priority determining unit 140E outputs second priority information that is priority information indicating the second priority.

The peripheral information updating unit 130E executes priority adjustment processing (step ST575).

In the priority adjusting processing, the priority adjusting unit 150E in the peripheral information updating unit 130E receives the first priority information from the priority setting unit 131E and acquires the first priority. The priority adjusting unit 150E receives the second priority information from the sensor priority determining unit 140E and acquires the second priority. Using the first priority and the second priority, the priority adjusting unit 150E outputs the priority, which is information indicating the certainty relating to the detection point, on the basis of the first priority or the second priority.

Further, the priority adjusting unit 150E acquires the traveling status information from the traveling status recognizing unit 120E. The priority adjusting unit 150E adjusts the priority by using the traveling status information and outputs the adjusted priority.

A specific example of the priority adjusting processing will be described with reference to the drawings.

The priority adjusting unit 150E executes first adjustment processing (step ST5751).

In the first adjustment processing, the first adjustment unit 151 in the priority adjusting unit 150E first acquires the second priority from the sensor priority determining unit 140E. The first adjustment unit 151 adjusts the priority, which is information indicating the certainty relating to the detection point for each of the detection points by using the second priority and outputs the adjusted priority.

An example of a method of adjusting the priority by the first adjustment unit 151 will be described.

For example, when it is determined that the host vehicle is traveling in a tunnel or traveling at night on the basis of the traveling status information, the first adjustment unit 151 lowers the priority of the detection point detected by the camera. As a result, it is possible to suppress occurrence of unintended control due to erroneous detection even in a case of a time or a status in which erroneous detection is likely to occur in sensing by a camera, such as nighttime or in a tunnel.

In addition, the first adjustment unit 151 is not limited to the traveling status or the time zone, and the present disclosure can be implemented even if the method of adjusting the priority is not limited to this as long as it is a method of recognizing the weather or the like by the traveling status information including the sensing result by the in-vehicle sensor, and performing priority setting of suppressing the influence of erroneous detection of the sensor by adjusting the priority that is the priority of the sensor depending on the traveling status, such as changing the sensor priority depending on the weather.

When the adjustment is performed by the first adjustment unit 151, the priority adjusting unit 150E merges, for example, the detection information of each sensor on the basis of the adjusted priority.

Description will be provided assuming a case where as illustrated in FIG. 24, a host vehicle “V” is traveling, and assuming a case where another vehicle “TR” is traveling on the left front of the host vehicle “V”.

In FIG. 24, “L1”, “L2”, “L3”, and “L4” are white lines of the respective lanes, and “A1”, “A2”, and “A3” represent the respective lanes.

The host vehicle “V” is traveling on the lane “A2”, and the point at which the millimeter wave radar (periphery detection sensor 210) detects the vehicle “TR” is the detection point “DP”.

Here, FIG. 25 illustrates sensing results under the same status as FIG. 24 by the camera (periphery detection sensor 210), and “BB1” and “BB2” are bounding boxes of the detection results by the camera.

Here, “BB1” is a bounding box of a detection result when the vehicle “TR” is detected, and “BB2” is a bounding box generated by erroneous detection.

For “BB1” and “BB2”, the distance and size from the host vehicle are estimated according to the size of the bounding box, and it is determined whether there is a detection point at a position coinciding with the detection point of the millimeter wave.

In this case, “BB1” and “DP” are regarded as having detected the same target, and are adjusted to have a high priority as a more reliable detection point.

Since “BB2” has no detection point of the millimeter wave radar, it is regarded as a detection point with low reliability and adjusted to a low priority.

When the priority is mapped as illustrated in FIG. 24 by the priority map generating unit 160E, the priority may be further adjusted on the basis of the priority map.

In the first adjustment processing, the detection points are merged in consideration of the second priority that is the priority of the sensor.

Upon completion of the priority adjustment processing, the priority adjusting unit 150E waits for the start of the next processing.

The description returns to FIG. 23.

The peripheral information updating unit 130E executes priority assignment processing (step ST576).

In the priority assignment processing, the priority assigning unit 132E in the peripheral information updating unit 130E assigns a priority, which is information indicating the certainty relating to the detection point for each detection point, to peripheral information and outputs the peripheral information.

The priority assigning unit 132E determines a final priority for each detection point indicating each target.

The priority assigning unit 132E determines a detection point of a priority that does not satisfy a predetermined criterion, and deletes the detection point so as not to be included in information to be output. The priority assigning unit 132E deletes a detection point at which both of the first priority and the second priority do not exceed threshold values so as not to be included in the information to be output, for example, the detection point not satisfying a criterion such as a detection point at which both of the first priority and the second priority are equal to or greater than threshold values or a detection point at which either of the first priority and the second priority is equal to or greater than a threshold value.

Further, the priority assigning unit 132E may apply normalization processing for generating a variation in priority to the priorities of all the detection targets. As a result, the priority assigning unit 132E performs final adjustment on the priority so as to be easily used by the control determining unit 190E in the subsequent stage. Note that the present disclosure can be implemented even if the final adjustment method is not limited thereto.

The peripheral information updating unit 130E outputs the updated peripheral information (step ST577).

The peripheral information updating unit 130E outputs, to the control determining unit 190E, updated peripheral information that is peripheral information assigned with priority for each detection point adjusted by the first adjustment unit 151.

When the peripheral information updating unit 130E outputs the updated peripheral information, the processing ends.

Upon completion of the processing, the peripheral information updating unit 130E waits for the start of the next processing.

The description returns to FIG. 22.

The object detection device 100E executes control determination processing (step ST580).

Specifically, similarly to the control determining unit 190A, B, C, D described above, the control determining unit 190E in the object detection device 100E determines the control content for the vehicle present at the current position by using the information indicating the certainty relating to the detection point included in the updated peripheral information output by the peripheral information updating unit 130E. The control determining unit 190E outputs a control command that commands the control content to the vehicle control device 300 that controls the vehicle.

While the periphery of the current position is sensed, the object detection device 100E repeatedly executes the processing from step ST510 to step ST580.

The object detection device of the present disclosure is configured as follows.

The priority adjusting unit includes:
a first adjustment unit to adjust and output, for each of the detection points, the priority that is information indicating certainty relating to the detection point by using the second priority.

As a result, the present disclosure can further adjust the priority using a certain detection result depending on the traveling status, and thus can provide an object detection device that easily recognizes the accuracy of the detection point and outputs the detection point.

Furthermore, the present disclosure exhibits the same effect as the above effect by applying the above configuration to the object detection method or the program.

### Sixth Embodiment

In a sixth embodiment, the embodiment for adjusting a priority according to vehicle information will be described.

In the description of the sixth embodiment, description similar to the content already described will be appropriately omitted.

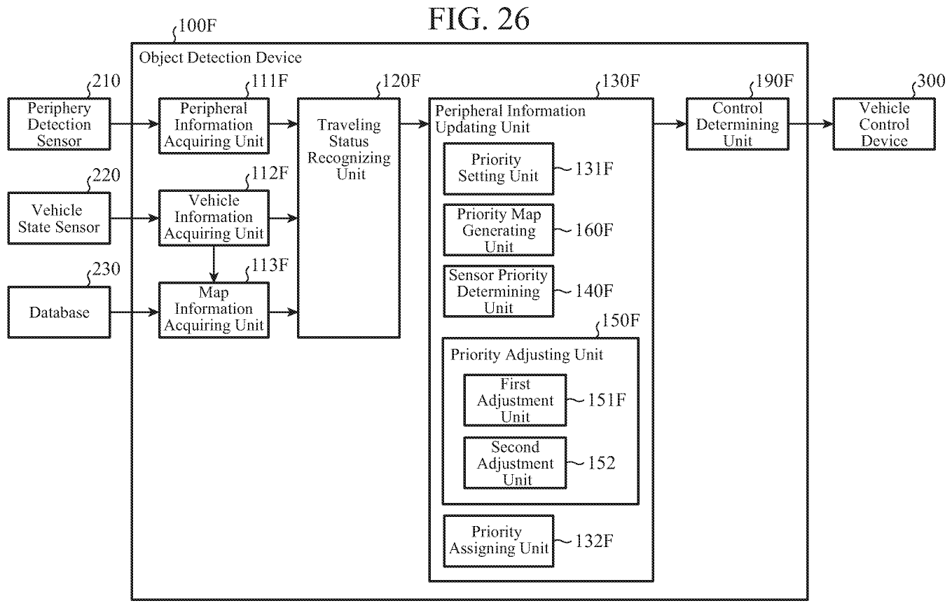

FIG. 26 is a diagram illustrating an example of a configuration of an object detection device 100F and its peripheral devices according to the sixth embodiment of the present disclosure.

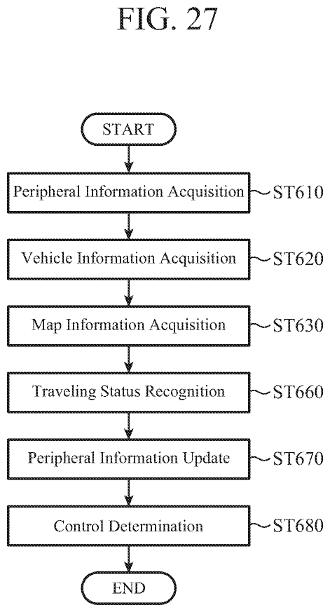

FIG. 27 is a flowchart illustrating an example of processing of the object detection device 100F according to the sixth embodiment of the present disclosure.

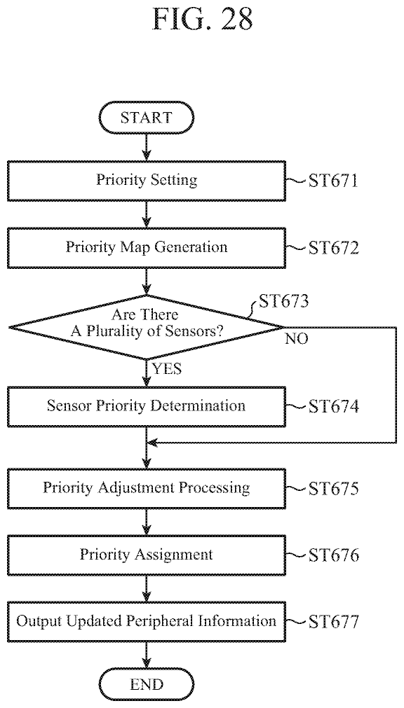

FIG. 28 is a flowchart illustrating an example of processing by a peripheral information updating unit 130F according to the sixth embodiment.

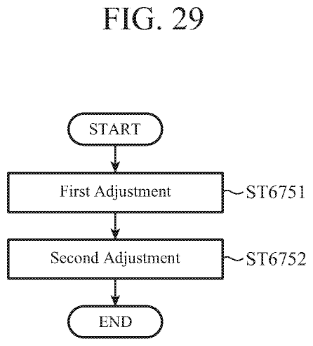

FIG. 29 is a flowchart illustrating an example of processing by a priority adjusting unit 150F according to the sixth embodiment.

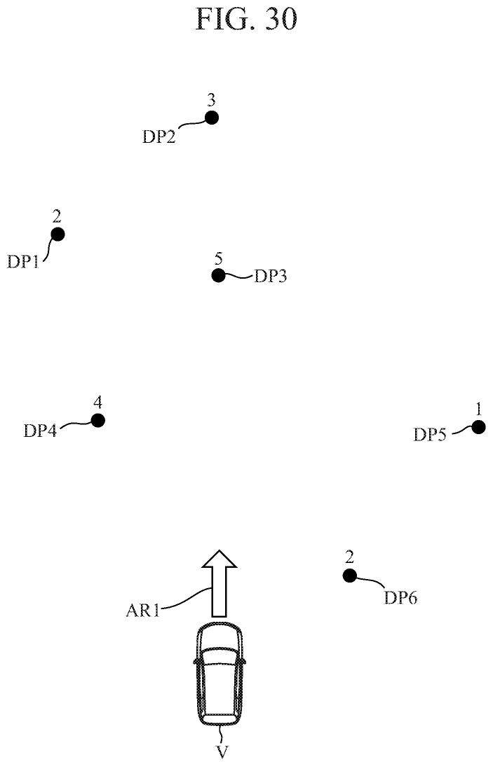

FIG. 30 is a diagram for describing a first example of an adjustment method by priority adjustment processing according to the sixth embodiment.

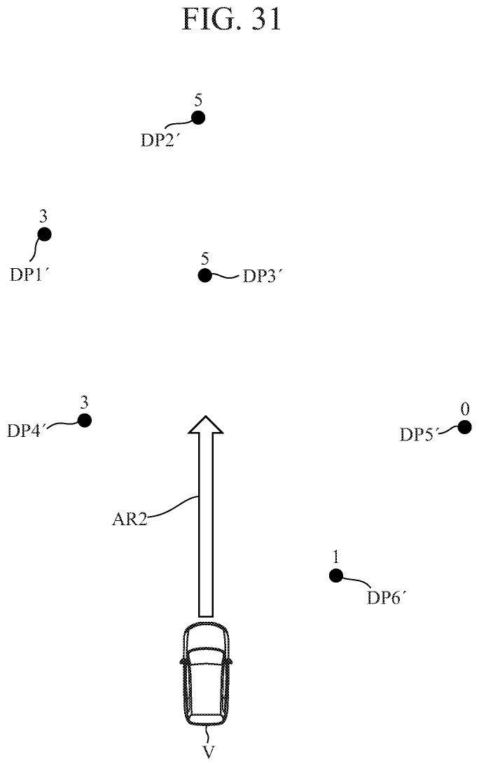

FIG. 31 is a diagram for describing a second example of the adjustment method by the priority adjustment processing according to the sixth embodiment.

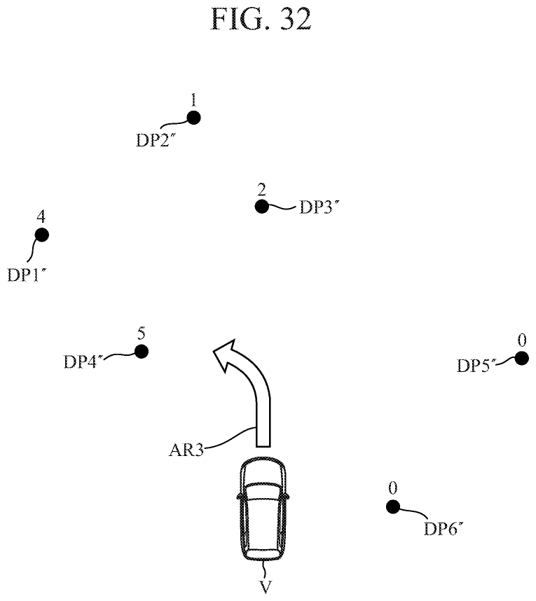

FIG. 32 is a diagram for describing a third example of the adjustment method by the priority adjustment processing according to the sixth embodiment.

The object detection device 100F illustrated in FIG. 26 is communicably connected to the periphery detection sensor 210, the vehicle state sensor 220, and the database 230.

The periphery detection sensor 210, the vehicle state sensor 220, and the database 230 are similar to the periphery detection sensor 210, the vehicle state sensor 220, and the database 230 already described in the second embodiment, respectively, and thus, detailed description thereof is omitted here.

The object detection device 100F includes a peripheral information acquiring unit 111F, a vehicle information acquiring unit 112F, a map information acquiring unit 113F, a traveling status recognizing unit 120F, a peripheral information updating unit 130F, a control determining unit 190F, a control unit (not illustrated), and a storage unit (not illustrated).

The peripheral information acquiring unit 111F, the vehicle information acquiring unit 112F, the map information acquiring unit 113F, and the traveling status recognizing unit 120F are similar to the peripheral information acquiring unit 111E, the vehicle information acquiring unit 112E, the map information acquiring unit 113E, and the traveling status recognizing unit 120E described above, respectively, and a detailed description thereof will be omitted here.

The peripheral information updating unit 130F includes a priority setting unit 131F, a priority map generating unit 160F, a sensor priority determining unit 140F, a priority adjusting unit 150F, and a priority assigning unit 132F.

The priority setting unit 131F, the priority map generating unit 160F, and the sensor priority determining unit 140F are similar to the priority setting unit 131E, the priority map generating unit 160E, and the sensor priority determining unit 140E described above, respectively, and detailed description thereof is omitted here.

The priority adjusting unit 150F is different from the priority adjusting unit 150E described above in that the priority adjusting unit 150F has a function of adjusting the priority using the vehicle information in addition to the function of the already described priority adjusting unit 150E.

The priority adjusting unit 150F includes a first adjustment unit 151F and a second adjustment unit 152.

Similarly to the first adjustment unit 151 described above, the first adjustment unit 151F adjusts the priority that is the information indicating the certainty relating to the detection point for each detection point by using the second priority and outputs the adjusted priority.

The second adjustment unit 152 adjusts the priority that is the information indicating the certainty relating to the detection point for each detection point by using the vehicle information, and outputs the adjusted priority.

The priority assigning unit 132F assigns a priority, which is information indicating the certainty relating to the detection point, to peripheral information for each detection point and outputs the peripheral information.

Specifically, the priority assigning unit 132F assigns, to the peripheral information, a priority after adjustment adjusted by the priority adjusting unit 150F, which is a priority that is information indicating the certainty relating to the detection point for each detection point, and outputs the updated peripheral information that is the peripheral information assigned with the priority.

The control determining unit 190F is similar to the control determining unit 190A, B, C, D, E described above, and a detailed description thereof will be omitted here.

The control unit (not illustrated) and the storage unit (not illustrated) are similar to the control unit and the storage unit that have already been described, and a detailed description thereof will be omitted here.

That is, in the object detection device 100F, the priority adjusting unit 150F includes the second adjustment unit 152 that adjusts the priority, which is the information indicating the certainty relating to the detection point for each detection point by using the vehicle information and outputs the adjusted priority.

The processing of the object detection device 100F will be described with reference to FIGS. 27, 28, 29, 30, 31, and 32.

The object detection device 100F, when starting the processing illustrated in FIG. 27, first executes peripheral information acquisition processing (step ST610).

In the peripheral information acquisition processing, the peripheral information acquiring unit 111F in the object detection device 100F acquires peripheral information including detection information for each detection point detected by sensing the periphery of the current position, similarly to the peripheral information acquiring unit 111A, B, C, D, E described above.

In addition, the peripheral information acquiring unit 111F acquires the peripheral information including detection information for each detection point detected by each of the plurality of sensors. Specifically, the peripheral information acquiring unit 111F acquires, for example, peripheral information including detection information for each detection point by the periphery detection sensors 210 of the group of the periphery detection sensors 210.

The object detection device 100F executes vehicle information acquisition processing (step ST620).

In the vehicle information acquisition processing, the vehicle information acquiring unit 112F in the object detection device 100F acquires vehicle information including a current position and a state of the vehicle present at the current position, similarly to the vehicle information acquiring unit 112A, B, C, D, E described above.

Specifically, the vehicle information acquiring unit 112F acquires, for example, vehicle information including a current position and a state of the host vehicle (the position and state of the vehicle present at the current position) output from the vehicle state sensors 220 constituting the vehicle state sensor group.

The object detection device 100F executes map information acquisition processing (step ST630).

In the map information acquisition processing, the map information acquiring unit 113F in the object detection device 100F acquires map information including a peripheral area of the current position, similarly to the map information acquiring unit 113A, B, C, D, E described above.

Specifically, for example, the map information acquiring unit 113F acquires vehicle information from the vehicle information acquiring unit 112F, and acquires peripheral map information based on the current position included in the vehicle information from the database 230.

For example, as illustrated in FIG. 6, the map information acquiring unit 113F acquires map information indicating a peripheral area of a current position by accessing the database 230 as needed via the Internet by using position information indicating the current position of the host vehicle.

Alternatively, for example, the map information acquiring unit 113F acquires map information indicating a peripheral area of the current position by accessing a memory in which the map information is stored in advance as needed.

The timing of acquiring the map information may be, for example, every time the current position is acquired or every fixed time interval.

The object detection device 100F executes traveling status recognition processing (step ST660).

In the traveling status recognition processing, similarly to the traveling status recognizing unit 120A, B, C, D, E described above, the traveling status recognizing unit 120F in the object detection device 100F outputs the traveling status information indicating the traveling status of the vehicle present at the current position and the status around the vehicle by using the peripheral information, the vehicle information, and the map information.

The object detection device 100F executes peripheral information update processing (step ST670).

In the peripheral information update processing, the peripheral information updating unit 130F in the object detection device 100F outputs information indicating the certainty relating to the detection point for each of the detection points by using the traveling status information.

The peripheral information updating unit 130F sets the first priority or the second priority for each detection point in the peripheral area of the current position by using the traveling status information, and outputs the priority, which is information indicating the certainty relating to the detection point for each detection point by using at least the first priority or the second priority.

A specific example of the peripheral information update processing will be described with reference to FIG. 28.

The peripheral information updating unit 130F executes priority setting processing (step ST671).

In the priority setting processing, the priority setting unit 131F in the object detection device 100F sets the first priority for each detection point in the peripheral area of the current position by using the traveling status information, similarly to the priority setting unit 131A, B, C, D, E described above. The priority setting unit 131F outputs first priority information indicating the first priority.

The peripheral information updating unit 130F executes priority map generation processing (step ST672).

In the priority map generation processing, similarly to the priority map generating unit 160, E described above, the priority map generating unit 160F in the object detection device 100F generates the priority map indicating the priority for each position included in the peripheral area of the current position by using the peripheral information, the map information, the vehicle information, and the traveling status information.

The peripheral information updating unit 130F determines whether there are a plurality of sensors (step ST673).

Specifically, the sensor priority determining unit 140F in the object detection device 100F determines whether there are a plurality of (two or more kinds, or two or more) periphery detection sensors 210 by using, for example, sensor identification information included in detection information of peripheral information acquired by the peripheral information acquiring unit 111F. Alternatively, the sensor priority determining unit 140F may determine whether there are a plurality of periphery detection sensors 210 by using information related to the periphery detection sensors 210 stored in advance.

The peripheral information updating unit 130F, when determining that there is no plurality of sensors (step ST673 “NO”), proceeds to processing of step ST675.

The peripheral information updating unit 130F, when determining that there are a plurality of sensors (step ST673 “YES”), executes sensor priority determination processing (step ST674).

In the sensor priority determination processing, the sensor priority determining unit 140F in the object detection device 100F acquires the vehicle information acquired by the vehicle information acquiring unit 112F similarly to the sensor priority determining unit 140, C, D, E described above. At this time, the sensor priority determining unit 140F can directly acquire the vehicle information from the vehicle information acquiring unit 112F, or can acquire the vehicle information via the traveling status recognizing unit 120F.

The sensor priority determining unit 140F acquires the map information acquired by the map information acquiring unit 113F. The map information can be directly acquired from the map information acquiring unit 113F, or the map information can be acquired via the traveling status recognizing unit 120F.

The sensor priority determining unit 140F acquires the traveling status information output by the traveling status recognizing unit 120F.

Similarly to the sensor priority determining unit 140, C, D, E described above, the sensor priority determining unit 140F uses the vehicle information, the map information, and the traveling status information to determine the second priority for each sensor that outputs the detection information included in the peripheral information.

For example, when one radar sensor using a millimeter wave radar and one imaging sensor using a camera are used as the periphery detection sensor 210, the sensor priority determining unit 140F determines the second priority indicating the certainty relating to the traveling status for each of the detection point detected by the radar sensor and the detection point detected by the imaging sensor.

Note that, for example, in a case where the number of types of the periphery detection sensors 210 is one and the number of the periphery detection sensors 210 is two or more, such as a case where the sensors in the group of the periphery detection sensors 210 are millimeter wave radars of the same type, the sensor priority determining unit 140F may determine the priority depending on the traveling status for each of the sensors.

The sensor priority determining unit 140F outputs second priority information indicating the second priority.

The peripheral information updating unit 130F executes priority adjustment processing (step ST675).

In the priority adjustment processing, the priority adjusting unit 150F in the peripheral information updating unit 130F receives the first priority information from the priority setting unit 131F and acquires the first priority. The priority adjusting unit 150F receives the second priority information from the sensor priority determining unit 140F and acquires the second priority. As a result, the priority assigning unit 132F obtains only the first priority, only the second priority, or both the first priority and the second priority for each detection point. The priority adjusting unit 150F outputs the priority that is information indicating the certainty relating to the detection point on the basis of the first priority or the second priority by using at least one of the first priority and the second priority.

Further, the priority adjusting unit 150F acquires the traveling status information from the traveling status recognizing unit 120F. The priority adjusting unit 150F adjusts the priority using the traveling status information and outputs the adjusted priority.

Further, the priority adjusting unit 150F acquires the vehicle information from the vehicle information acquiring unit 112F. The priority adjusting unit 150F adjusts the priority using the vehicle information and outputs the adjusted priority.

A specific example of the priority adjustment processing will be described with reference to FIG. 29.

The priority adjusting unit 150F executes first adjustment processing (step ST6751).

In the first adjustment processing, the first adjustment unit 151F in the priority adjusting unit 150F first acquires the second priority from the sensor priority determining unit 140F. Similarly to the first adjustment unit 151 described above, the first adjustment unit 151F adjusts the priority that is the information indicating the certainty relating to the detection point for each of the detection points by using the second priority and outputs the adjusted priority.

An example of a method of adjusting the priority by the first adjustment unit 151F will be described.

For example, when it is determined that the host vehicle is traveling in a tunnel or traveling at night, the first adjustment unit 151F lowers the priority of the detection point detected by the camera. As a result, it is possible to suppress occurrence of unintended control due to erroneous detection even in a case of a time or a status in which erroneous detection is likely to occur in sensing by a camera, such as nighttime or in a tunnel.

In addition, the first adjustment unit 151F is not limited to the traveling status or the time zone, and the present disclosure can be implemented even if the method of adjusting the priority is not limited to this as long as the priority setting is performed to suppress the influence of erroneous detection of the sensor by recognizing the weather or the like by the in-vehicle sensor and adjusting the priority that is the priority of the sensor depending on the traveling status, such as changing the sensor priority depending on the weather.

The priority adjusting unit 150F executes second adjustment processing (step ST6752).

In the second adjustment processing, the second adjustment unit 152 in the priority adjusting unit 150F first acquires the vehicle information acquired by the vehicle information acquiring unit 112F. The second adjustment unit 152 adjusts the priority that is the information indicating the certainty relating to the detection point for each detection point by using the vehicle information, and outputs the adjusted priority.

An example of a method of adjusting the priority by the second adjustment unit 152 will be described.

The second adjustment unit 152 adjusts the priority for each detection point according to the vehicle information such as the vehicle speed and the yaw rate of the host vehicle “V” included in the vehicle information.

In FIGS. 30 and 31, “DP1”, “DP2”, “DP3”, “DP4”, “DP5”, “DP6”, “DP1′”, “DP2′”, “DP3′”, “DP4′”, “DP5′”, and “DP6′” are vectors respectively indicating detection points detected by the periphery detection sensors 210, and “AR1” and “AR2” are vectors respectively indicating the traveling direction of the host vehicle V and the magnitude of the vehicle speed.

When the vehicle speed is low as illustrated in FIG. 30, the second adjustment unit 152 performs the adjustment to lower the priority of distant detection point “DP2”.

The second adjustment unit 152 adjusts the priority of detection point “DP4” near the host vehicle V from the middle to the high because the detection point “DP4” is a target not on the straight route but considered to come out on the straight route.

On the other hand, when the vehicle speed is high as illustrated in FIG. 31, the second adjustment unit 152 adjusts the detection point “DP4′”, which is separated from the traveling direction in the direction orthogonal to the traveling direction at the neighboring detection point, and the detection point “DP5”, which is further separated from the traveling direction, so that the priorities are lowered.

This is because, in a case where the speed of the vehicle is high, there is a possibility that the vehicle contacts a detection point far in the traveling direction, and the detection point is likely to be a control determination target, and conversely, it can be estimated that the vehicle passes a detection point separated in a direction orthogonal to the traveling direction before contact, and the detection point is less likely to be a control determination target in many cases.

Further, as illustrated in FIG. 32, when the host vehicle “V” travels with acceleration in the lateral direction while turning to the right or left as in the vector “AR3”, the entry direction of the host vehicle “V” is dynamically calculated from the yaw rate information included in the vehicle information such as the detection points “DP1″”, “DP2″”, “DP3″”, “DP4″”, “DP5″”, and “DP6″”, and the priority is sequentially adjusted to be high for the detection points in the entry direction of the vehicle “V”, and the priority is lowered for the detection points on the side opposite to the entry direction of the vehicle.

As described above, the object detection device 100F adjusts the priority of the peripheral detection target from the vehicle information such as the speed and the yaw rate of the vehicle, thereby being able to obtain the result of the peripheral recognition corresponding to the movement of the vehicle in real time, and generate the detection point information for more appropriate control.

Upon completion of the priority adjustment processing, the priority adjusting unit 150F waits for the start of the next processing.

The description returns to FIG. 28.

The peripheral information updating unit 130F executes priority assignment processing (step ST676).

In the priority assignment processing, the priority assigning unit 132F in the peripheral information updating unit 130F assigns a priority, which is information indicating the certainty relating to the detection point for each detection point, to peripheral information and outputs the peripheral information, similarly to the priority assigning unit 132E described above.

The peripheral information updating unit 130F outputs the updated peripheral information (step ST677).

The peripheral information updating unit 130F outputs, to the control determining unit 190F, updated peripheral information that is peripheral information assigned with the priority for each detection point adjusted by the second adjustment unit 152.

When the peripheral information updating unit 130F outputs the updated peripheral information, the processing ends.

Upon completion of the processing, the peripheral information updating unit 130F waits for the start of the next processing.

The description returns to FIG. 27.

The object detection device 100F executes control determination processing (step ST680).

Specifically, similarly to the control determining unit 190A, B, C, D, E described above, the control determining unit 190F in the object detection device 100F determines the control content for the vehicle present at the current position by using the information indicating the certainty relating to the detection point included in the updated peripheral information output by the peripheral information updating unit 130F. The control determining unit 190F outputs a control command that commands the control content to the vehicle control device 300 that controls the vehicle.

While the periphery of the current position is sensed, the object detection device 100F repeatedly executes the processing from step ST610 to step ST680.

The object detection device of the present disclosure is configured as follows.

The priority adjusting unit includes:
a second adjustment unit to adjust and output, for each of the detection points, the priority that is information indicating certainty relating to the detection point by using the vehicle information.

As a result, the present disclosure further has an effect of providing an object detection device that easily recognizes the accuracy of the detection point according to the state of the vehicle and outputs the detection point.

Furthermore, the present disclosure exhibits the same effect as the above effect by applying the above configuration to the object detection method or the program.

### Seventh Embodiment

In a seventh embodiment, the embodiment for further acquiring roadside-device information from the roadside device 240 and using the roadside-device information will be described.

In the description of the seventh embodiment, description similar to the content already described will be appropriately omitted.

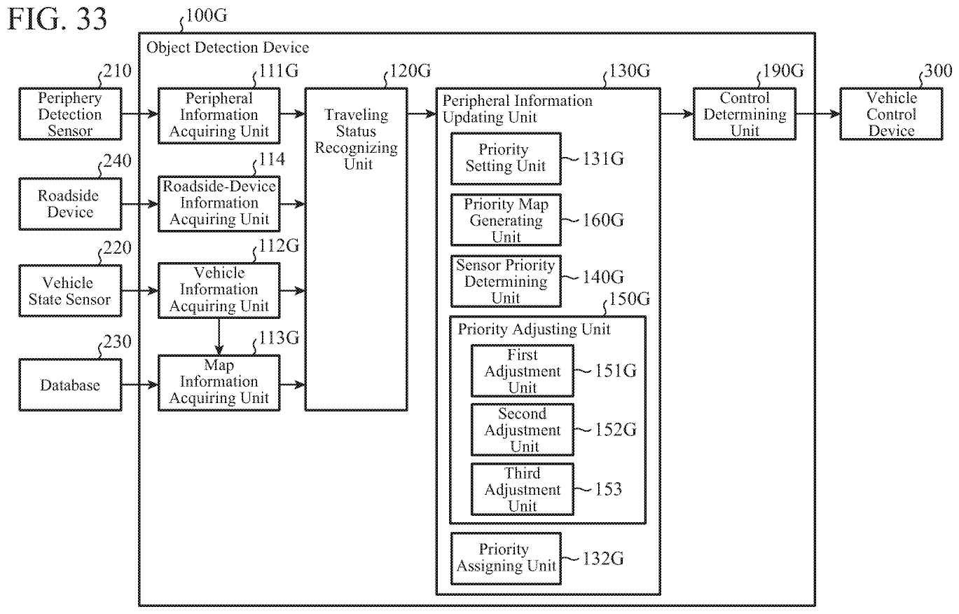

FIG. 33 is a diagram illustrating an example of a configuration of an object detection device 100G and its peripheral devices according to the seventh embodiment of the present disclosure.

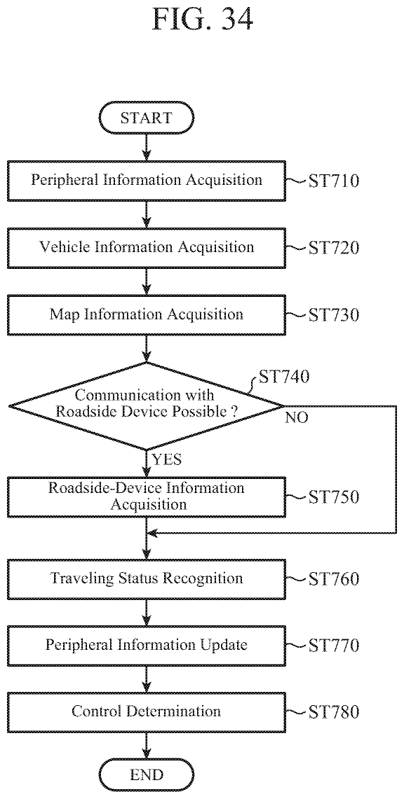

FIG. 34 is a flowchart illustrating an example of processing of the object detection device 100G according to the seventh embodiment of the present disclosure.

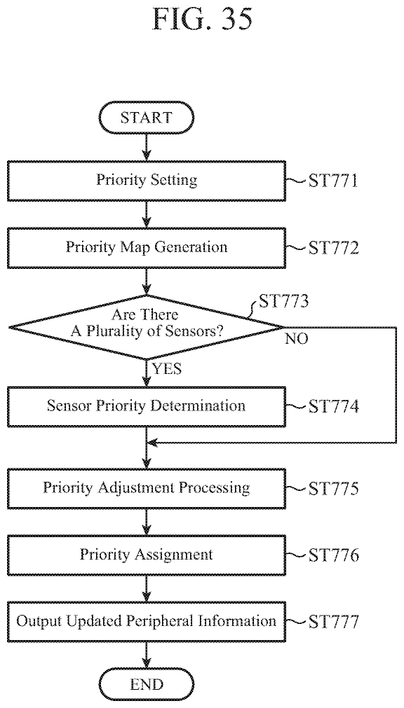

FIG. 35 is a flowchart illustrating an example of processing by a peripheral information updating unit 130G according to the seventh embodiment.

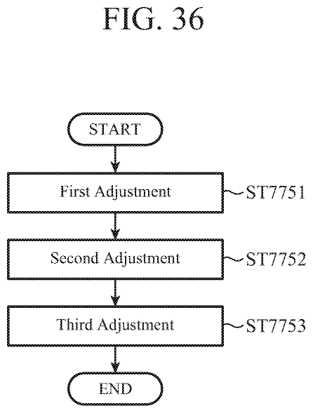

FIG. 36 is a flowchart illustrating an example of processing by a priority adjusting unit 150G according to the seventh embodiment.

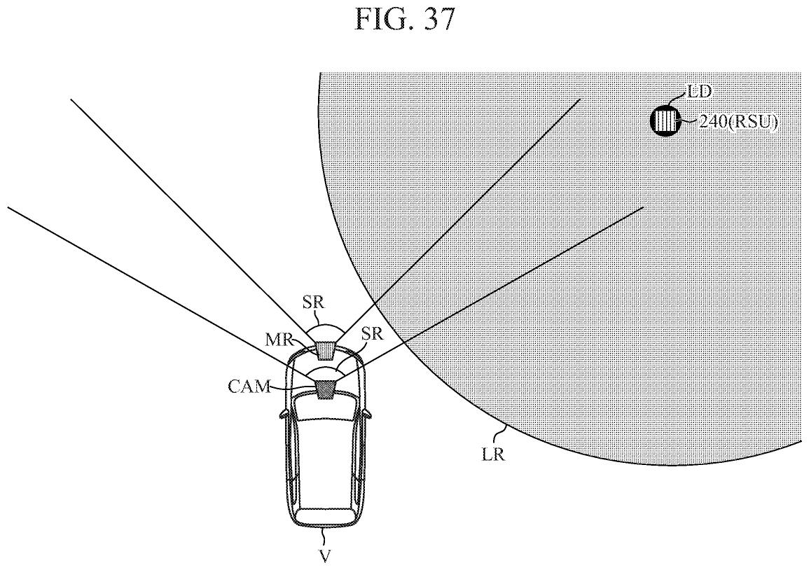

FIG. 37 is a diagram for describing an example of a periphery detection sensor 210 that detect a periphery and a roadside device 240 in the seventh embodiment.

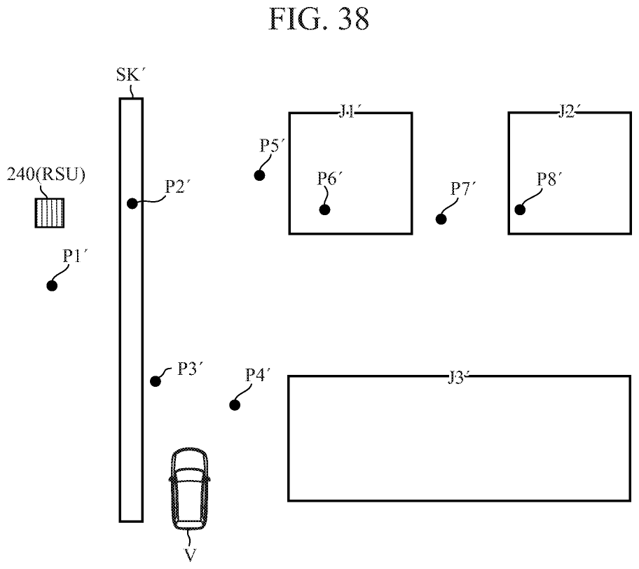

FIG. 38 is a diagram for describing an example of an adjustment method by priority adjustment processing according to the seventh embodiment.

The object detection device 100G illustrated in FIG. 33 is communicably connected to the periphery detection sensor 210, the vehicle state sensor 220, the database 230, and the roadside device 240.

The periphery detection sensor 210, the vehicle state sensor 220, and the database 230 are similar to the periphery detection sensor 210, the vehicle state sensor 220, and the database 230 described above, respectively, and thus detailed description thereof is omitted here.

The roadside device 240 is a roadside unit (RSU) capable of communicating with a traveling vehicle. In the description, the roadside device 240 is also referred to as an RSU.

The roadside device 240 can detect a target around the roadside device 240 by a sensor.

The sensor of the roadside device 240 is, for example, Light Detection and Ranging (LiDAR). When the sensor of the roadside device 240 is a LiDAR, it is also referred to as an LD (see FIG. 37) in the description.

The detection range LR of LiDAR is more preferably, for example, about 50 m around the roadside device 240.

However, the sensor of the roadside device 240 is not limited to the LiDAR, and the present disclosure can be implemented as long as the sensor has equivalent detection performance.

The roadside device 240 transmits detection information indicating a result of detection of a target by the roadside device 240 to the vehicle when there is a communicable vehicle in the vicinity and communication with the vehicle becomes possible.

The object detection device 100G includes a peripheral information acquiring unit 111G, a vehicle information acquiring unit 112G, a map information acquiring unit 113G, a roadside-device information acquiring unit 114, a traveling status recognizing unit 120G, a peripheral information updating unit 130G, a priority setting unit 131G, a priority assigning unit 132G, a sensor priority determining unit 140G, a priority adjusting unit 150G, a control determining unit 190G, a control unit (not illustrated), and a storage unit (not illustrated).

The peripheral information acquiring unit 111G acquires peripheral information including detection information for each detection point detected by sensing the periphery of the current position, similarly to the peripheral information acquiring unit 111A, B, C, D, E, F described above.

The vehicle information acquiring unit 112G acquires vehicle information including a current position and a state of the vehicle present at the current position, similarly to the vehicle information acquiring unit 112A, B, C, D, E, F described above.

The map information acquiring unit 113G acquires map information including a peripheral area of the current position similarly to the map information acquiring unit 113A, B, C, D, E, F described above.

The roadside-device information acquiring unit 114 acquires roadside-device information from the roadside device 240.

The roadside-device information acquiring unit 114 determines whether or not communication with the roadside device 240 is possible, and acquires the roadside-device information by receiving the roadside-device information transmitted by the roadside device 240 when it is determined that communication is possible. The received roadside-device information includes peripheral target information based on the position of the roadside device 240.

Note that the roadside-device information acquiring unit 114 may be provided inside the peripheral information acquiring unit 111G.

Similarly to the traveling status recognizing unit 120A, B, C, D, E, F described above, the traveling status recognizing unit 120G outputs traveling status information indicating the traveling status of the vehicle present at the current position and the status around the vehicle by using the peripheral information, the vehicle information, and the map information.

In addition, the traveling status recognizing unit 120G further uses the roadside-device information to output traveling status information indicating a vehicle present at the current position and a traveling status around the vehicle.

That is, the traveling status recognizing unit 120G outputs the traveling status information indicating the traveling status of the vehicle present at the current position and the status around the vehicle by using the peripheral information, the vehicle information, the map information, and the roadside-device information.

The peripheral information updating unit 130G outputs information indicating the certainty relating to the detection point for each detection point by using the traveling status information.

Specifically, for example, the peripheral information updating unit 130G outputs a priority, which is information indicating the certainty relating to the detection point for each detection point, by using the traveling status information.

The peripheral information updating unit 130G updates peripheral information including detection information for each detection point.

The peripheral information updating unit 130G sets a first priority for each detection point in the peripheral area of the current position by using the traveling status information, and outputs a priority that is information indicating the certainty relating to the detection point for each detection point by using the first priority.

In addition, the peripheral information updating unit 130G outputs a priority that is information indicating the certainty relating to the detection point by using the first priority and the second priority.

The peripheral information updating unit 130G includes a priority setting unit 131G, a priority map generating unit 160G, a sensor priority determining unit 140G, a priority adjusting unit 150G, and a priority assigning unit 132G.

The priority setting unit 131G sets the first priority for each detection point in the peripheral area of the current position by using the traveling status information.

The priority map generating unit 160G generates a priority map indicating the priority for each position included in the peripheral area of the current position by using the peripheral information, the map information, the vehicle information, and the traveling status information.

The sensor priority determining unit 140G determines a second priority for each sensor that outputs detection information included in the peripheral information, by using the vehicle information, the map information, and the traveling status information.

The priority adjusting unit 150G outputs a priority that is information indicating the certainty relating to the detection point on the basis of the first priority or the second priority by using the first priority and the second priority.

The priority adjusting unit 150G outputs a priority that is information indicating the certainty relating to the detection point on the basis of the first priority and the second priority by using the first priority and the second priority.

The priority adjusting unit 150G includes a first adjustment unit 151G, a second adjustment unit 152G, and a third adjustment unit 153.

Similarly to the first adjustment unit 151, F described above, the first adjustment unit 151G adjusts the priority that is the information indicating the certainty relating to the detection point for each detection point by using the second priority and outputs the adjusted priority.

Similarly to the second adjustment unit 152 described above, the second adjustment unit 152G uses the vehicle information to adjust and output the priority that is the information indicating the certainty relating to the detection point for each detection point.

The third adjustment unit 153 uses the roadside-device information to adjust and output the priority that is the information indicating the certainty relating to the detection point for each detection point.

The priority assigning unit 132G assigns a priority, which is information indicating the certainty relating to the detection point, to peripheral information for each detection point and outputs the peripheral information.

Specifically, the priority assigning unit 132G assigns a priority, which is information indicating the certainty relating to the detection point for each detection point and is adjusted by the priority adjusting unit 150G, to peripheral information and outputs the peripheral information.

The control determining unit 190G determines and determines the control content related to the detection point for the vehicle present at the current position by using the information indicating the certainty relating to the detection point included in the updated peripheral information output by the peripheral information updating unit 130G. A control command that commands the control content is output to the vehicle control device 300 that controls the vehicle.

The control determining unit 190G only needs to be able to suppress control that should not be performed originally on the basis of the priority of the detection point. For example, the control determining unit may determine whether or not to perform control, and may perform determination so as to change the strength of control depending on the level of priority for each detection point.

The control unit (not illustrated) and the storage unit (not illustrated) are similar to the control unit and the storage unit that have already been described, and a detailed description thereof will be omitted here.

The processing in the object detection device 100G will be described with reference to FIGS. 34, 35, 36, 37, and 38.

The object detection device 100G, when starting the processing illustrated in FIG. 34, first executes peripheral information acquisition processing (step ST710).

In the peripheral information acquisition processing, similarly to the peripheral information acquiring unit 111A, B, C, D, E, F described above, the peripheral information acquiring unit 111G in the object detection device 100G acquires peripheral information including detection information for each detection point detected by sensing the periphery of the current position.

In addition, the peripheral information acquiring unit 111G acquires the peripheral information including detection information for each detection point detected by each of the plurality of sensors. Specifically, the peripheral information acquiring unit 111G acquires, for example, peripheral information including detection information for each detection point by the periphery detection sensors 210 of the group of the periphery detection sensors 210.

The object detection device 100G executes vehicle information acquisition processing (step ST720).

In the vehicle information acquisition processing, the vehicle information acquiring unit 112G in the object detection device 100G acquires the vehicle information including a current position and a state of the vehicle present at the current position, similarly to the vehicle information acquiring unit 112A, B, C, D, E, F described above.

Specifically, the vehicle information acquiring unit 112G acquires, for example, vehicle information including a current position and a state of the host vehicle (the position and state of the vehicle present at the current position) output from the vehicle state sensors 220 constituting the vehicle state sensor group.

The object detection device 100G executes map information acquisition processing (step ST730).

In the map information acquisition processing, the map information acquiring unit 113G in the object detection device 100G acquires map information including a peripheral area of the current position similarly to the map information acquiring unit 113A, B, C, D, E, F described above.

Specifically, for example, the map information acquiring unit 113G acquires vehicle information from the vehicle information acquiring unit 112G, and acquires peripheral map information based on the current position included in the vehicle information from the database 230.

The object detection device 100G determines whether communication with the roadside machine 240 is possible (step ST740).

Specifically, the roadside-device information acquiring unit 114 in the object detection device 100G attempts to always receive information transmitted from the roadside device 240 while the host vehicle is traveling, and determines whether the object detection device 100G and the roadside device 240 can communicate with each other.

The object detection device 100G, when determining that the object detection device 100G and the roadside device 240 can communicate with each other (step ST740 “YES”), executes roadside-device information acquisition processing (step ST750).

Specifically, the roadside-device information acquiring unit 114 in the object detection device 100G, when determining that the object detection device 100G and the roadside device 240 can communicate with each other while the host vehicle is traveling, acquires the roadside-device information. The roadside-device information acquiring unit 114 outputs the roadside-device information to the traveling status recognizing unit 120G and the peripheral information updating unit 130G.

The object detection device 100G executes traveling status recognition processing (step ST760).

In the traveling status recognition processing, the traveling status recognizing unit 120G in the object detection device 100G outputs traveling status information indicating the traveling status of the vehicle present at the current position and the status around the vehicle by using the peripheral information, the vehicle information, the map information, and the roadside-device information.

The traveling status recognizing unit 120G acquires the peripheral information acquired by the peripheral information acquiring unit 111G.

The traveling status recognizing unit 120G acquires the vehicle information acquired by the vehicle information acquiring unit 112G.

The traveling status recognizing unit 120G acquires the map information acquired by the map information acquiring unit 113G.

The traveling status recognizing unit 120G acquires the roadside-device information acquired by the roadside-device information acquiring unit 114.

For example, the traveling status recognizing unit 120G recognizes a traveling status such as host vehicle peripheral classification and detailed information thereof in addition to a traveling position of the host vehicle, a speed of the host vehicle, a traveling direction of the host vehicle, a point where the host vehicle is traveling and a peripheral state, a position of a peripheral structure or the like, and a position of a detection point with reference to the host vehicle by combining the peripheral information, the vehicle information, the map information, and the roadside-device information, and outputs a recognition result as traveling status information.

The host vehicle peripheral classification and the detailed information thereof are similar to the contents described above.

The object detection device 100G executes peripheral information update processing (step ST770).

In the peripheral information update processing, the peripheral information updating unit 130G in the object detection device 100G outputs information indicating the certainty relating to the detection point for each of the detection points by using the traveling status information.

The peripheral information updating unit 130G sets the first priority or the second priority for each detection point in the peripheral area of the current position by using the traveling status information, and outputs the priority which is information indicating the certainty relating to the detection point for each detection point by using at least the first priority or the second priority.

A specific example of the peripheral information update processing will be described with reference to FIG. 35.

The peripheral information updating unit 130G executes priority setting processing (step ST771).

In the priority setting processing, the priority setting unit 131G in the object detection device 100G sets the first priority for each detection point in the peripheral area of the current position by using the traveling status information. The priority setting unit 131G outputs first priority information indicating the first priority.

The peripheral information updating unit 130G executes priority map generation processing (step ST772).

In the priority map generation processing, the priority map generating unit 160G in the object detection device 100G generates the priority map indicating the priority for each position included in the peripheral area of the current position by using the peripheral information, the map information, the vehicle information, and the traveling status information.

The peripheral information updating unit 130G determines whether there are a plurality of sensors (step ST773).

Specifically, the sensor priority determining unit 140G in the object detection device 100G determines whether there are a plurality of (two or more kinds, or two or more) periphery detection sensors 210 by using, for example, sensor identification information included in detection information of peripheral information acquired by the peripheral information acquiring unit 111G. Alternatively, the sensor priority determining unit 140G may determine whether there are a plurality of periphery detection sensors 210 by using information related to the periphery detection sensors 210 stored in advance.

The peripheral information updating unit 130G, when determining that there is no plurality of sensors (step ST773 “NO”), proceeds to processing of step ST775.

The peripheral information updating unit 130G, when determining that there are a plurality of sensors (step ST773 “YES”), executes sensor priority determination processing (step ST774).

In the sensor priority determination processing, the sensor priority determining unit 140G in the object detection device 100G acquires the vehicle information acquired by the vehicle information acquiring unit 112G. At this time, the sensor priority determining unit 140G can directly acquire the vehicle information from the vehicle information acquiring unit 112G, or can acquire the vehicle information via the traveling status recognizing unit 120G.

The sensor priority determining unit 140G acquires the map information acquired by the map information acquiring unit 113G. The map information can be directly acquired from the map information acquiring unit 113G, or the map information can be acquired via the traveling status recognizing unit 120G.

The sensor priority determining unit 140G acquires the traveling status information output by the traveling status recognizing unit 120G.

Similarly to the sensor priority determining unit 140C, D, E, F described above, the sensor priority determining unit 140G uses the vehicle information, the map information, and the traveling status information to determine the second priority for each sensor that outputs the detection information included in the peripheral information.

The sensor priority determining unit 140G outputs second priority information indicating the second priority.

The peripheral information updating unit 130G executes priority adjustment processing (step ST775).

In the priority adjustment processing, the priority adjusting unit 150G in the peripheral information updating unit 130G receives the first priority information from the priority setting unit 131G and acquires the first priority. The priority adjusting unit 150G receives the second priority information from the sensor priority determining unit 140G and acquires the second priority.

Using the first priority and the second priority, the priority adjusting unit 150G outputs a priority that is information indicating the certainty relating to the detection point on the basis of the first priority or the second priority. In this case, the priority adjusting unit 150G compares, for example, the first priority with the second priority to determine either of them, and calculates the priority based on the first priority or the second priority.

Alternatively, the priority adjusting unit 150G outputs the priority that is the information indicating the certainty relating to the detection point on the basis of the first priority and the second priority by using the first priority and the second priority. In this case, for example, the priority adjusting unit 150G calculates the priority in which the second priority is added to the first priority for the detection point at which both the first priority and the second priority are equal to or greater than the threshold value.

Further, the priority adjusting unit 150G acquires the traveling status information from the traveling status recognizing unit 120G. The priority adjusting unit 150G adjusts the priority using the traveling status information and outputs the adjusted priority.

Further, the priority adjusting unit 150G acquires the vehicle information from the vehicle information acquiring unit 112G. The priority adjusting unit 150G adjusts the priority using the vehicle information and outputs the adjusted priority.

Further, the priority adjusting unit 150G acquires the roadside-device information from the roadside-device information acquiring unit 114. The priority adjusting unit 150G adjusts the priority using the roadside-device information and outputs the adjusted priority.

A specific example of the priority adjustment processing will be described with reference to FIG. 36.

The priority adjusting unit 150G executes first adjustment processing (step ST7751).

In the first adjustment processing, the first adjustment unit 151G in the priority adjusting unit 150G first acquires the second priority from the sensor priority determining unit 140G. Similarly to the first adjustment unit 151F described above, the first adjustment unit 151G adjusts the priority that is the information indicating the certainty relating to the detection point for each detection point by using the second priority and outputs the adjusted priority.

The priority adjusting unit 150G executes second adjustment processing (step ST7752).

In the second adjustment processing, the second adjustment unit 152G in the priority adjusting unit 150G first acquires the vehicle information acquired by the vehicle information acquiring unit 112G. Similarly to the second adjustment unit 152 described above, the second adjustment unit 152G uses the vehicle information to adjust and output the priority that is the information indicating the certainty relating to the detection point for each detection point.

The priority adjusting unit 150G executes third adjustment processing (step ST7753).

In the third adjustment processing, the third adjustment unit 153G in the priority adjusting unit 150G acquires the roadside-device information output from the roadside device 240. The third adjustment unit 153G uses the roadside-device information to adjust and output the priority that is information indicating the certainty relating to the detection point for each of the detection points.

An example of a method of adjusting the priority by the third adjustment unit 153 will be described.

The third adjustment unit 153 adjusts the priority of the peripheral detection target detected by the periphery detection sensor 210 on the basis of detection information (roadside-device information) on the roadside device 240 side obtained from the roadside device 240.

Description will be provided assuming a case where as illustrated in FIG. 38, a host vehicle “V” traveling on a road where a roadside device 240 is installed on a roadside detects detection points “P1′”, “P2′”, “P3′”, “P4′”, “P5′”, “P6′”, “P7′”, and “P8′” indicating detection targets, and the roadside device 240 detects the detection points “P2′”, “P3′”, “P4′”, and “P5′”.

When the roadside device 240 detects a target, the third adjustment unit 153 adjusts the priority of the detection target in the peripheral area to be high. In this case, the third adjustment unit 153 increases the priorities of the detection points “P2′”, “P3′”, “P4′”, and “P5′”.

On the other hand, when the roadside device 240 does not detect “P1′”, “P2′”, “P3′”, “P4′”, and “P5′”, the third adjustment unit 153 adjusts the priorities of the detection points “P1′”, “P2′”, “P3′”, “P4′”, and “P5′” detected on the host vehicle “V” side to be low.

When there is no communication from the roadside device 240, the third adjustment unit 153 adjusts the priority by focusing on detection information that is a detection result of the periphery detection sensor 210 on the vehicle “V” side.

In this manner, by adjusting the priority with respect to the detection information on the vehicle “V” side on the basis of the detection information by the roadside device 240, it is possible to obtain detection information with higher reliability.

Upon completion of the priority adjustment processing, the priority adjusting unit 150G waits for the start of the next processing.

The description returns to FIG. 35.

The peripheral information updating unit 130G executes priority assignment processing (step ST776).

In the priority assignment processing, the priority assigning unit 132G in the peripheral information updating unit 130G assigns a priority, which is information indicating the certainty relating to the detection point for each detection point, to peripheral information and outputs the peripheral information. Specifically, for example, the priority assigning unit 132G acquires the first priority and the second priority, assigns a priority that is information indicating the certainty relating to the detection point to the peripheral information for each detection point by using the first priority and the second priority, and outputs the updated peripheral information that is the peripheral information assigned with the priority.

The priority assigning unit 132G acquires the adjusted priority from the priority adjusting unit 150G, and determines the final priority for each detection point indicating each target.

The priority assigning unit 132G determines a detection point of a priority that does not satisfy a predetermined criterion, and deletes the detection point so as not to be included in information to be output. The priority assigning unit 132G deletes a detection point at which both of the first priority and the second priority do not exceed threshold values so as not to be included in the information to be output, for example, the detection point not satisfying a criterion such as a detection point at which both of the first priority and the second priority are equal to or greater than threshold values or a detection point at which either of the first priority and the second priority is equal to or greater than a threshold value.

Further, the priority assigning unit 132G may apply normalization processing for generating a variation in priority to the priorities of all the detection targets. As a result, the priority assigning unit 132G performs final adjustment on the priority so as to be easily used in the control determining unit 190G in the subsequent stage. Note that the present disclosure can be implemented even if the final adjustment method is not limited thereto.

The peripheral information updating unit 130G outputs the updated peripheral information (step ST777).

The peripheral information updating unit 130G outputs, to the control determining unit 190G, updated peripheral information that is peripheral information assigned with a priority for each detection point adjusted by the third adjustment unit 153.

When the peripheral information updating unit 130G outputs the updated peripheral information, the processing ends.

Upon completion of the processing, the peripheral information updating unit 130G waits for the start of the next processing.

The description returns to FIG. 34.

The object detection device 100G executes control determination processing (step ST780).

Specifically, similarly to the control determining unit 190A, B, C, D, E, F described above, the control determining unit 190G in the object detection device 100G determines the control content for the vehicle present at the current position by using the information indicating the certainty relating to the detection point included in the updated peripheral information output by the peripheral information updating unit 130G. The control determining unit 190G outputs a control command that commands the control content to the vehicle control device 300 that controls the vehicle.

While the periphery of the current position is sensed, the object detection device 100G repeatedly executes the processing from step ST710 to step ST780.

The object detection device of the present disclosure is further configured as follows.

The object detection device further includes a roadside-device information acquiring unit to acquire roadside-device information from a roadside device, and the traveling status recognizing unit outputs traveling status information indicating a vehicle present at a current position and a traveling status around the vehicle by further using the roadside-device information.

As a result, the present disclosure further has an effect of being able to provide an object detection device capable of recognizing a traveling status around a vehicle present at a current position from a line-of-sight at another angle such as a roadside device and further improving accuracy of detecting an object.

Furthermore, the present disclosure exhibits the same effect as the above effect by applying the above configuration to the object detection method or the program.

The object detection device of the present disclosure is further configured as follows.

The object detection device further includes a roadside-device information acquiring unit to acquire roadside-device information from a roadside device, and
the priority adjusting unit includes:
a third adjustment unit to adjust and output, for each of the detection points, the priority that is information indicating certainty relating to the detection point by using the roadside-device information.

As a result, the present disclosure further has an effect of being able to provide an object detection device capable of outputting a detection result so that accuracy of a detection point can be recognized more accurately by using a result of recognizing a traveling status around a vehicle present at a current position from a line-of-sight at another angle such as a roadside device.

Furthermore, the present disclosure exhibits the same effect as the above effect by applying the above configuration to the object detection method or the program.

Here, a hardware configuration for implementing the functions related to the object detection device 100, 100A, 100B, 100C, 100D, 100E, 100F, 100G of the present disclosure will be described.

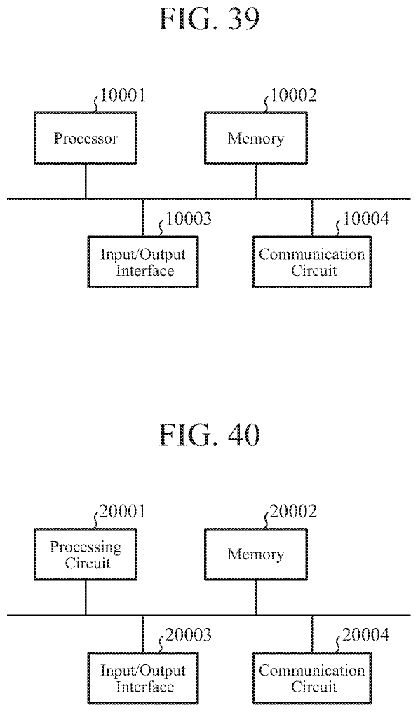

FIG. 39 is a diagram illustrating a first example of a hardware configuration for implementing the functions related to the object detection device 100, 100A, 100B, 100C, 100D, 100E, 100F, 100G of the present disclosure.

FIG. 40 is a diagram illustrating a second example of a hardware configuration for implementing the functions related to the object detection device 100, 100A, 100B, 100C, 100D, 100E, 100F, 100G of the present disclosure.

The object detection device 100, 100A, 100B, 100C, 100D, 100E, 100F, 100G of the present disclosure is implemented by hardware as illustrated in FIG. 39 or 40.

As illustrated in FIG. 39, the object detection device 100, 100A, 100B, 100C, 100D, 100E, 100F, 100G includes, for example, a processor 10001, a memory 10002, an input/output interface 10003, and a communication circuit 10004.

The processor 10001 and the memory 10002 are mounted on a computer, for example.

The memory 10002 stores a program for causing the computer to function as a peripheral information acquiring unit 111A, 111B, 111C, 111D, 111E, 111F, 111G; a vehicle information acquiring unit 112, 112A, 112B, 112C, 112D, 112E, 112F, 112G; a map information acquiring unit 113, 113A, 113B, 113C, 113D, 113E, 113F, 113G; a roadside-device information acquiring unit 114; a traveling status recognizing unit 120, 120A, 120A, 120B, 120C, 120D, 120E, 120F, 120G; a peripheral information updating unit 130, 130A, 130B, 130C, 130D, 130E, 130F, 130G; a priority setting unit 131, 131B, 131C, 131D, 131E, 131F, 131G; a priority assigning unit 132, 132B, 132C, 132D, 132E, 132F, 132G, a sensor priority determining unit 140, 140C, 140D, 140E, 140F, 140G, a priority adjusting unit 150, 150D, 150E, 150F, 150G, a first adjustment unit 151, 151F, 151G, a second adjustment unit 152, 152G, a third adjustment unit 153, a priority map generating unit 160, 160E, 160F, 160G, a control determining unit 190, 190B, 190C, 190D, 190E, 190F, 190G, and a control unit (not illustrated). When the processor 10001 reads and executes the program stored in the memory 10002, the functions of the peripheral information acquiring unit 111A, 111B, 111C, 111D, 111E, 111F, 111G; the vehicle information acquiring unit 112, 112A, 112B, 112C, 112D, 112E, 112F, 112G; the map information acquiring unit 113, 113A, 113B, 113C, 113D, 113E, 113F, 113G; the roadside-device information acquiring unit 114; the traveling status recognizing unit 120, 120A, 120A, 120B, 120C, 120D, 120E, 120F, 120G; the peripheral information updating unit 130, 130A, 130B, 130C, 130D, 130E, 130F, 130G; the priority setting unit 131, 131B, 131C, 131D, 131E, 131F, 131G; the priority assigning unit 132, 132B, 132C, 132D, 132E, 132F, 132G, the sensor priority determining unit 140, 140C, 140D, 140E, 140F, 140G, the priority adjusting unit 150, 150D, 150E, 150F, 150G, the first adjustment unit 151, 151F, 151G, the second adjustment unit 152, 152G, the third adjustment unit 153, the priority map generating unit 160, 160E, 160F, 160G, the control determining unit 190, 190B, 190C, 190D, 190E, 190F, 190G, and the control unit (not illustrated) are implemented.

In addition, a storage unit (not illustrated) is implemented by the memory 10002 or another memory (not illustrated).

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magneto-optical disk.

The processor 10001 and the memory 10002 are connected in a state in which data can be transmitted to each other. In addition, the processor 10001 and the memory 10002 are connected in a state in which data can be mutually transmitted with other hardware via the input/output interface 10003.

Alternatively, the functions of the peripheral information acquiring unit 111A, 111B, 111C, 111D, 111E, 111F, 111G; the vehicle information acquiring unit 112, 112A, 112B, 112C, 112D, 112E, 112F, 112G; the map information acquiring unit 113, 113A, 113B, 113C, 113D, 113E, 113F, 113G; the roadside-device information acquiring unit 114; the traveling status recognizing unit 120, 120A, 120A, 120B, 120C, 120D, 120E, 120F, 120G; the peripheral information updating unit 130, 130A, 130B, 130C, 130D, 130E, 130F, 130G; the priority setting unit 131, 131B, 131C, 131D, 131E, 131F, 131G; the priority assigning unit 132, 132B, 132C, 132D, 132E, 132F, 132G, the sensor priority determining unit 140, 140C, 140D, 140E, 140F, 140G, the priority adjusting unit 150, 150D, 150E, 150F, 150G, the first adjustment unit 151, 151F, 151G, the second adjustment unit 152, 152G, the third adjustment unit 153, the priority map generating unit 160, 160E, 160F, 160G, the control determining unit 190, 190B, 190C, 190D, 190E, 190F, 190G, and the control unit (not illustrated) may be implemented by a dedicated processing circuit 20001 as illustrated in FIG. 40.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

In addition, a storage unit (not illustrated) is implemented by the memory 20002 or another memory (not illustrated).

The memory 20002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disk such as a compact disc (CD) or a digital versatile disc (DVD), or may be a magneto-optical disk.

The processing circuit 20001 and the memory 20002 are connected in a state in which data can be transmitted to each other. In addition, the processing circuit 20001 and the memory 20002 are connected in a state in which data can be mutually transmitted with other hardware via the input/output interface 20003.

Note that the functions of the peripheral information acquiring unit 111A, 111B, 111C, 111D, 111E, 111F, 111G; the vehicle information acquiring unit 112, 112A, 112B, 112C, 112D, 112E, 112F, 112G; the map information acquiring unit 113, 113A, 113B, 113C, 113D, 113E, 113F, 113G; the roadside-device information acquiring unit 114; the traveling status recognizing unit 120, 120A, 120A, 120B, 120C, 120D, 120E, 120F, 120G; the peripheral information updating unit 130, 130A, 130B, 130C, 130D, 130E, 130F, 130G; the priority setting unit 131, 131B, 131C, 131D, 131E, 131F, 131G; the priority assigning unit 132, 132B, 132C, 132D, 132E, 132F, 132G, the sensor priority determining unit 140, 140C, 140D, 140E, 140F, 140G, the priority adjusting unit 150, 150D, 150E, 150F, 150G, the first adjustment unit 151, 151F, 151G, the second adjustment unit 152, 152G, the third adjustment unit 153, the priority map generating unit 160, 160E, 160F, 160G, the control determining unit 190, 190B, 190C, 190D, 190E, 190F, 190G, and the control unit (not illustrated) may be implemented by different processing circuits, or may be collectively implemented by processing circuits.

Alternatively, a part of the functions of the peripheral information acquiring unit 111A, 111B, 111C, 111D, 111E, 111F, 111G; the vehicle information acquiring unit 112, 112A, 112B, 112C, 112D, 112E, 112F, 112G; the map information acquiring unit 113, 113A, 113B, 113C, 113D, 113E, 113F, 113G; the roadside-device information acquiring unit 114; the traveling status recognizing unit 120, 120A, 120A, 120B, 120C, 120D, 120E, 120F, 120G; the peripheral information updating unit 130, 130A, 130B, 130C, 130D, 130E, 130F, 130G; the priority setting unit 131, 131B, 131C, 131D, 131E, 131F, 131G; the priority assigning unit 132, 132B, 132C, 132D, 132E, 132F, 132G, the sensor priority determining unit 140, 140C, 140D, 140E, 140F, 140G, the priority adjusting unit 150, 150D, 150E, 150F, 150G, the first adjustment unit 151, 151F, 151G, the second adjustment unit 152, 152G, the third adjustment unit 153, the priority map generating unit 160, 160E, 160F, 160G, the control determining unit 190, 190B, 190C, 190D, 190E, 190F, 190G, and the control unit (not illustrated) may be implemented by the processor 10001 and the memory 10002, and the remaining functions may be implemented by the processing circuit 20001.

Note that, within the scope of the present disclosure, the present disclosure can freely combine each embodiment, modify any component of each embodiment, or omit any component of each embodiment.

The object detection device of the present disclosure can output a detection result so that accuracy of a detection point based on a signal acquired by a sensor can be recognized, and thus is suitable for use in, for example, an object detection device that detects an object for controlling a vehicle.

### REFERENCE SIGNS LIST

100, 100A, 100B, 100C, 100D, 100E, 100F, 100G: object detection device, 111, 111A, 111B, 111C, 111D, 111E, 111F, 111G: peripheral information acquiring unit, 112, 112A, 112B, 112C, 112D, 112E, 112F, 112G: vehicle information acquiring unit, 113, 113A, 113B, 113C, 113D, 113E, 113F, 113G: map information acquiring unit, 114: roadside-device information acquiring unit, 120, 120A, 120A, 120B, 120C, 120D, 120E, 120F, 120G: traveling status recognizing unit, 130, 130A, 130B, 130C, 130D, 130E, 130F, 130G: peripheral information updating unit, 131, 131B, 131C, 131D, 131E, 131F, 131G: priority setting unit, 132, 132B, 132C, 132D, 132E, 132F, 132G: priority assigning unit, 140, 140C, 140D, 140E, 140F, 140G: sensor priority determining unit, 150, 150D, 150E, 150F, 150G: priority adjusting unit, 151, 151F, 151G: first adjustment unit, 152, 152G: second adjustment unit, 153: third adjustment unit, 160, 160E, 160F, 160G: priority map generating unit, 190, 190B, 190C, 190D, 190E, 190F, 190G: control determining unit, 210: periphery detection sensor (periphery detection sensor group), 220: vehicle state sensor (vehicle state sensor group), 230: database, 240: roadside device, 300: vehicle control device

What is claimed is:

1. An object detection device comprising:
processing circuitry:
to acquire peripheral information including detection information for each of detection points detected by sensing a periphery of a current position;
to acquire vehicle information including a current position and a state of a vehicle present at the current position;
to acquire map information including a peripheral area of a current position;
to output traveling status information indicating a traveling state of a vehicle present at a current position and a status around the vehicle by using the peripheral information, the vehicle information, and the map information; and
to output, for each of the detection points, information indicating certainty relating to a detection point by using the traveling status information.

2. The object detection device according to claim 1, wherein
the processing circuitry outputs, for each of the detection points, a priority that is information indicating certainty relating to the detection point by using the traveling status information.

3. The object detection device according to claim 2, wherein
the processing circuitry includes to set a first priority for each of detection points in a peripheral area of a current position by using the traveling status information, and
the processing circuitry outputs, for each of the detection points, the priority that is information indicating certainty relating to the detection point by using the first priority.

4. The object detection device according to claim 3, wherein
the processing circuitry acquires the peripheral information including detection information for each of detection points detected by each of a plurality of sensors,
the processing circuitry includes to determine a second priority for each of sensors that output detection information included in the peripheral information by using the vehicle information, the map information, and the traveling status information, and
the processing circuitry outputs the priority that is information indicating certainty relating to the detection point by using the first priority and the second priority.

5. The object detection device according to claim 4, wherein
the processing circuitry includes:
to output the priority that is information indicating certainty relating to the detection point on a basis of the first priority or the second priority by using the first priority and the second priority.

6. The object detection device according to claim 4, wherein
the processing circuitry includes:
to output the priority that is information indicating certainty relating to the detection point on a basis of the first priority and the second priority by using the first priority and the second priority.

7. The object detection device according to claim 3, wherein
the processing circuitry includes:
to assign, to the peripheral information, the priority that is information indicating certainty relating to the detection point, and
the processing circuitry outputs updated peripheral information that is the peripheral information assigned with the priority.

8. The object detection device according to claim 5, wherein
the processing circuitry includes:
to assign, to the peripheral information, the priority that is information indicating certainty relating to the detection point, and
the processing circuitry outputs updated peripheral information that is the peripheral information assigned with the priority.

9. The object detection device according to claim 6, wherein
the processing circuitry includes:
to assign, to the peripheral information, the priority that is information indicating certainty relating to the detection point, and
the processing circuitry outputs updated peripheral information that is the peripheral information assigned with the priority.

10. The object detection device according to claim 2, wherein
the processing circuitry includes:
to generate a priority map indicating a priority for each of positions included in a peripheral area of a current position by using the peripheral information, the map information, the vehicle information, and the traveling status information, and
the processing circuitry determines, for each of the detection points, the priority that is information indicating certainty relating to the detection point by using the priority map.

11. The object detection device according to claim 5, wherein
the processing circuitry includes:
to generate a priority map indicating a priority for each of positions included in a peripheral area of a current position by using the peripheral information, the map information, the vehicle information, and the traveling status information, and
the processing circuitry determines, for each of the detection points, the priority that is information indicating certainty relating to the detection point by using the priority map.

12. The object detection device according to claim 6, wherein
the processing circuitry includes:
to generate a priority map indicating a priority for each of positions included in a peripheral area of a current position by using the peripheral information, the map information, the vehicle information, and the traveling status information, and
the processing circuitry determines, for each of the detection points, the priority that is information indicating certainty relating to the detection point by using the priority map.

13. The object detection device according to claim 7, wherein
the processing circuitry includes:
to generate a priority map indicating a priority for each of positions included in a peripheral area of a current position by using the peripheral information, the map information, the vehicle information, and the traveling status information, and
the processing circuitry determines, for each of the detection points, the priority that is information indicating certainty relating to the detection point by using the priority map.

14. The object detection device according to claim 8, wherein
the processing circuitry includes:
to generate a priority map indicating a priority for each of positions included in a peripheral area of a current position by using the peripheral information, the map information, the vehicle information, and the traveling status information, and
the processing circuitry determines, for each of the detection points, the priority that is information indicating certainty relating to the detection point by using the priority map.

15. The object detection device according to claim 5, wherein
the processing circuitry includes:
to adjust and output, for each of the detection points, the priority that is information indicating certainty relating to the detection point by using the second priority.

16. The object detection device according to claim 14, wherein
the processing circuitry includes:
to adjust and output, for each of the detection points, the priority that is information indicating certainty relating to the detection point by using the second priority.

17. The object detection device according to claim 5, wherein
the processing circuitry includes:
to adjust and output, for each of the detection points, the priority that is information indicating certainty relating to the detection point by using the vehicle information.

18. The object detection device according to claim 14, wherein
the processing circuitry includes:
to adjust and output, for each of the detection points, the priority that is information indicating certainty relating to the detection point by using the vehicle information.

19. The object detection device according to claim 16, wherein
the processing circuitry includes:
to adjust and output, for each of the detection points, the priority that is information indicating certainty relating to the detection point by using the vehicle information.

20. The object detection device according to claim 1, the processing circuitry further comprising:
to acquire roadside-device information from a roadside device, wherein
the processing circuitry outputs traveling status information indicating a vehicle present at a current position and a traveling status around the vehicle by further using the roadside-device information.

21. The object detection device according to claim 5, the processing circuitry further comprising:
to acquire roadside-device information from a roadside device, wherein
the processing circuitry outputs traveling status information indicating a vehicle present at a current position and a traveling status around the vehicle by further using the roadside-device information.

22. The object detection device according to claim 5, the processing circuitry further comprising:
to acquire roadside-device information from a roadside device, wherein
the processing circuitry includes:
to adjust and output, for each of the detection points, the priority that is information indicating certainty relating to the detection point by using the roadside-device information.

23. The object detection device according to claim 14, the processing circuitry further comprising:
to acquire roadside-device information from a roadside device, wherein
the processing circuitry includes:
to adjust and output, for each of the detection points, the priority that is information indicating certainty relating to the detection point by using the roadside-device information.

24. The object detection device according to claim 16, the processing circuitry further comprising:
to acquire roadside-device information from a roadside device, wherein
the processing circuitry includes:
to adjust and output, for each of the detection points, the priority that is information indicating certainty relating to the detection point by using the roadside-device information.

25. The object detection device according to claim 18, the processing circuitry further comprising:
to acquire roadside-device information from a roadside device, wherein
the processing circuitry includes:
to adjust and output, for each of the detection points, the priority that is information indicating certainty relating to the detection point by using the roadside-device information.

26. The object detection device according to claim 19, the processing circuitry further comprising:
to acquire roadside-device information from a roadside device, wherein
the processing circuitry includes:
to adjust and output, for each of the detection points, the priority that is information indicating certainty relating to the detection point by using the roadside-device information.

27. The object detection device according to claim 21, wherein
the processing circuitry includes:
to adjust and output, for each of the detection points, the priority that is information indicating certainty relating to the detection point by using the roadside-device information.

28. The object detection device according to claim 1 the processing circuitry further comprising:
to determine a control content for a vehicle present at a current position by using information indicating certainty relating to the detection point included in the updated peripheral information output, and output a control command that commands the control content to a vehicle control device that controls the vehicle.

29. An object detection method, the object detection method comprising:
acquiring peripheral information including detection information for each of detection points detected by sensing a periphery of a current position;
acquiring vehicle information including a current position and a state of a vehicle present at the current position;
acquiring map information including a peripheral area of a current position;
outputting traveling status information indicating a vehicle present at a current position and a traveling status around the vehicle by using the peripheral information, the vehicle information, and the map information; and
outputting, for each of the detection points, information indicating certainty relating to a detection point by using the traveling status information.

30. A non-transitory computer readable storage medium storing a program for causing a computer to execute a process, the process comprising:
to acquire peripheral information including detection information for each of detection points detected by sensing a periphery of a current position;
to acquire vehicle information including a current position and a state of a vehicle present at the current position;
to acquire map information including a peripheral area of a current position;
to output traveling status information indicating a vehicle present at a current position and a traveling status around the vehicle by using the peripheral information, the vehicle information, and the map information; and
to output, for each of the detection points, information indicating certainty relating to a detection point by using the traveling status information.
